(19) United States
(12) Patent Application Publication
(10) Pub. No.: US 2016/0132040 A1
(43) Pub. Date: May 12, 2016

(54) CONNECTION RELATION DETECTING SYSTEM, INFORMATION PROCESSING APPARATUS, AND CONNECTION RELATION DETECTING METHOD

(71) Applicant: Renesas Electronics Corporation, Tokyo (JP)

(72) Inventors: Koichiro NOGUCHI, Tokyo (JP); Osamu OKAZAKI, Tokyo (JP); Shunichi KAERIYAMA, Tokyo (JP)

(21) Appl. No.: 14/886,025

(22) Filed: Oct. 17, 2015

(30) Foreign Application Priority Data
Nov. 11, 2014 (JP) 2014-229024

(51) Int. Cl. G05B 19/4099

(52) U.S. Cl. CPC G05B 19/4099; G05B 2219/49023

(57) ABSTRACT

A connection relation detecting system according to the present invention includes a plurality of modules which include a plurality of connection ports which can connect with another module, and an information processing device which, when the plurality of modules are connected with each other, is connected to one of the plurality of modules through the connection ports. Each of the plurality of modules includes a connection changing unit which connects the connection ports inside the module in response to a connection change request from the information processing device. The information processing device includes a connection detecting unit which, when the information processing device makes the connection change request to the module, detects a module newly recognized through the module as a module connected to the module to which the connection change request is made.

### CROSS-REFERENCE TO RELATED APPLICATIONS

This application is based upon and claims the benefit of priority from Japanese patent application No. 2014-229024, filed on Nov. 11, 2014, the disclosure of which is incorporated herein in its entirety by reference.

### BACKGROUND

The present invention relates to a connection relation detecting system, an information processing apparatus and a connection relation detecting method, and relates to, for example, a technique of detecting a connection relation of a plurality of modules.

Japanese Unexamined Patent Application Publication No. 2003-132373 discloses a system whose object is to efficiently generate a three-dimensional virtual model which represents an actual object. The system disclosed in Japanese Unexamined Patent Application Publication No. 2003-132373 includes a plurality of components and an information processing system. A plurality of components can form a physical model.

Each component includes a controller. The controller detects a presence of and connection with another component. In this regard, this controller detects the presence of and connection with another component by detecting the shortest distance between the controller and another component according to a radio signal or detecting a mechanical movement amount in a connector. Further, the controller transmits information for identifying connection with another component, to the information processing system by way of wireless communication. The information processing system generates a virtual model corresponding to a physical model by using information transmitted from the controller.

### SUMMARY

However, when the controller disclosed in Japanese Unexamined Patent Application Publication No. 2003-132373 is a component, there is a problem that the system is highly costly and consumes high power.

For example, this controller detects a shortest distance between the controller and another component according to a radio signal. However, it is necessary to detect a fine distance difference based on a radio wave intensity of a radio signal, and a complex algorithm for calculating the shortest distance based on this detection result is necessary.

Further, this controller detects a mechanical movement amount in the connector from another viewpoint. However, electrodes which can identify a mechanical movement amount need to be provided to each connector. That is, not only the detection algorithm but also a physical shape of the connector become complex.

As described above, in the system disclosed in Japanese Unexamined Patent Application Publication No. 2003-132373, a highly sensitive radio signal sensor which can detect a fine distance difference, and a highly functional controller which includes a CPU (Central Processing Unit) which can execute the complex algorithm need to be mounted on each component, and therefore there is a problem that the system becomes highly costly and consumes high power.

The other problems and new features will become apparent from the description and the accompanying drawings of the description.

According to one embodiment, when a plurality of modules including a plurality of connection ports are connected with each other through the connection ports, a connection relation detecting system connects connection ports inside a module, and detects a module newly recognized through the module as a module connected to the module in which the connection ports are connected.

According to the above embodiment, it is possible to reduce cost and power consumption.

### BRIEF DESCRIPTION OF THE DRAWINGS

The above and other aspects, advantages and features will be more apparent from the following description of certain embodiments taken in conjunction with the accompanying drawings, in which:

FIG. 1 is a view illustrating an outline of a first embodiment;

FIG. 2 is a view illustrating an example of a module according to the first embodiment;

FIG. 3 is a view illustrating a schematic configuration of a virtual model generating system according to the first embodiment;

FIG. 4 is a view illustrating a schematic configuration of a connection changing function according to the first embodiment;

FIG. 5 is a view illustrating a connection example of the module according to the first embodiment;

FIG. 6 is a flowchart illustrating a schematic operation of the virtual model generating system according to the first embodiment;

FIG. 7 is a flowchart illustrating a schematic operation of connection relation acquisition processing of the virtual model generating system according to the first embodiment;

FIG. 8 is a view illustrating a configuration of the virtual model generating system according to the first embodiment;

FIG. 9 is a view illustrating a configuration of a server according to the first embodiment;

FIG. 10 is a view illustrating a relation between a module ID linking database and information of each database according to the first embodiment;

FIG. 11 is a view illustrating a hardware configuration of the server according to the first embodiment;

FIG. 12 is a view illustrating a configuration of a host according to the first embodiment;

FIG. 13 is a view illustrating a hardware configuration of the host according to the first embodiment;

FIG. 14 is a view illustrating a configuration of a module according to the first embodiment;

FIG. 15 is a view illustrating a first configuration example of the module according to the first embodiment;

FIG. 16 is a view illustrating a hardware configuration of the first configuration example of the module according to the first embodiment;

FIG. 17 is a view illustrating a second configuration example of the module according to the first embodiment;

FIG. 18 is a view illustrating a hardware configuration of the second configuration example according to the first embodiment;

FIG. 19 is a flowchart illustrating an operation of the virtual model generating system according to the first embodiment;

FIG. 20 is a flowchart illustrating an operation of the connection relation acquisition processing of the virtual model generating system according to the first embodiment;

FIG. 21 is a flowchart illustrating an operation of the server according to the first embodiment;

FIG. 22 is a flowchart illustrating an operation of the host according to the first embodiment;

FIG. 23 is a view conceptually illustrating a program example of recursive loop processing of the host according to the first embodiment;

FIG. 24 is a flowchart illustrating an operation of pre-processing of the host according to the first embodiment;

FIG. 25 is a flowchart illustrating an operation of module ID list acquisition processing of the host according to the first embodiment;

FIG. 26 is a view illustrating a frame format of I2C;

FIG. 27 is a flowchart illustrating an operation of the module according to the first embodiment;

FIG. 28 is a view illustrating a first state in a connection example of a module M according to the first embodiment;

FIG. 29 is a view illustrating information of a connection detecting database in the first state illustrated in FIG. 28;

FIG. 30 is a view illustrating a second state in a connection example of the module M according to the first embodiment;

FIG. 31 is a view illustrating information of the connection detecting database in the second state illustrated in FIG. 30;

FIG. 32 is a view illustrating configurations of a host and a module according to a second embodiment;

FIG. 33 is a view illustrating a module and a connection part according to a third embodiment;

FIG. 34 is a view illustrating a configuration of a host according to a fourth embodiment;

FIG. 35 is a view illustrating configurations of a host and a module according to a fifth embodiment;

FIG. 36 is a flowchart illustrating an operation of connection relation acquisition processing of a virtual model generating system according to another embodiment; and

FIG. 37 is a view illustrating a schematic configuration of a connection relation detecting system according to another embodiment.

### DETAILED DESCRIPTION

Preferable embodiments will be described below with reference to the drawings. Specific numerical values described in the following embodiments are exemplary to help one of ordinary skill in the art to easily understand the invention, and are not limited to these unless specified in particular. Further, matters which are obvious for one of ordinary skill in the art will be optionally omitted and simplified in the following description and the drawings for clarification of the description.

### First Embodiment

### Outline of First Embodiment

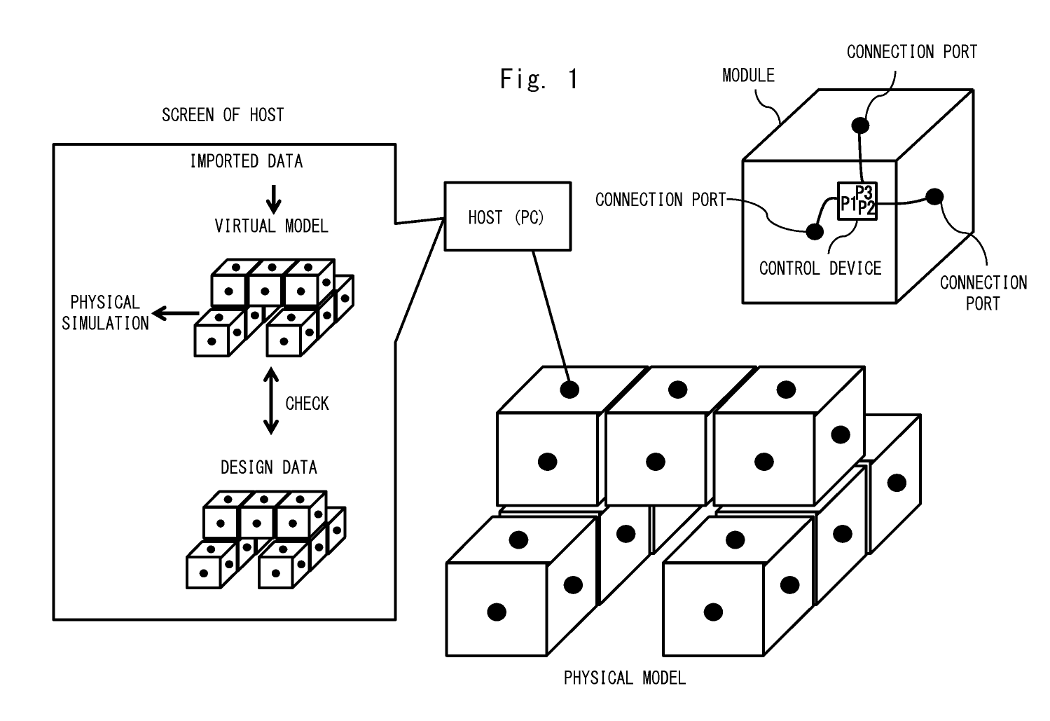

First, the outline of the first embodiment will be described with reference to FIG. 1. In the first embodiment, a platform which can create a home electrical appliance (also referred to as “home electronics” below) or an operating gadget by connecting each module as if assembling blocks is typically an application object.

Such a platform (1) first assembles a real thing and simulates a motion or (2) simulates a motion according to a model assembled on software and then assembles the real thing. However, when above (1) is performed, there is a problem that registering the same model as the real thing in software is very burdensome. Further, when above (2) is performed, there is a problem that it is difficult to check whether or not the real thing can be assembled similar to the model assembled on software.

For the above reasons, a function of assembling a real thing, then automatically reproducing a physical shape and a connection relation of the real thing and visualizing the real thing is convenient. A system which realizes such a function will be described in the first embodiment.

The user can create a physical model by connecting a plurality of modules with each other. This physical model configures, for example, the above home electronics or gadget. Each module is connected through a connection port included in each module. Each module includes at least one connection port. The number of connection ports may differ per module. Each connection portion included in each module is connected with each other through a control device built in this module.

A host computer (PC: Personal Computer) is connected to one of a plurality of modules which configures a physical model. The host computer will be also referred to as a “host” below. The host can communicate with a module to be connected with the host. The host can communicate with other modules, too, connected through this module. The host checks a connection relation of a plurality of modules by communicating with each of a plurality of modules which configure the physical model. The host generates a virtual model obtained by reproducing a physical model on software based on the connection relation of a plurality of modules checked in this way.

Further, according to one aspect, the host can perform a physical simulation based on the generated virtual model. Thus, the user can skip a labor of registering a physical model (real thing) in software when performing above (1).

Further, according to another aspect, the host can compare the generated virtual model and a model (design data) assembled on software, and check whether or not there is a difference between the virtual model and the model. Thus, when above (2) is performed, it is possible to easily check whether or not the real thing can be assembled similar to the model assembled on software. Further, by highlighting a portion corresponding to a compared difference in the model assembled on software and the generated virtual model, it is possible to easily recognize the difference.

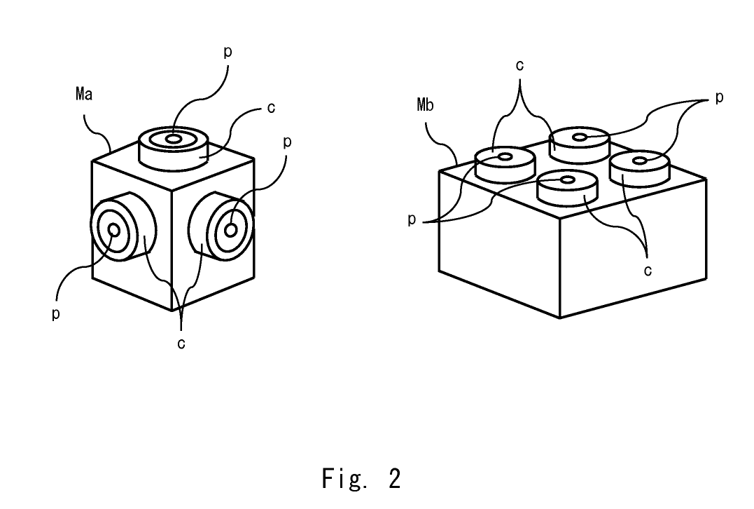

Subsequently, an example of the module according to the first embodiment will be described with reference to FIG. 2. Modules used to create a physical model may be simply, for example, blocks Ma and Mb illustrated in FIG. 2.

The module Ma includes one convex portion c on each of some of planes of a top surface and side surfaces. Each convex portion c includes a connection port p. In this regard, the convex portions are arranged on the three planes of the side surfaces of the module Ma which can be visually checked in FIG. 2. Further, the module Ma includes one concave portion on each of some of planes in a bottom surface and the side surfaces. The concave portion includes the connection port p (not illustrated). In this regard, the concave portions are arranged in the three planes of the side surfaces of the module Ma which cannot be visually checked in FIG. 2. A shape of a main body portion of the module Ma is preferably cubic except for the convex portions and the concave portions.

The convex portion c of the module Ma can be connected with the concave portion of another module Ma. By connecting the convex portion c of the module Ma and the concave portion of another module Ma, the connection port p of the convex portion c and the connection port p of the concave portion are connected.

The module Mb includes the four convex portions c in a top surface of the module Mb. Each convex portion c includes the connection portion p. Further, the module Mb includes four concave portions (not illustrated) in a bottom surface of the module Mb. Each concave portion includes the connection portion p (not illustrated). In addition, side surfaces of the module Mb do not include convex portions c and the concave portions, and are planar. A shape of a main body portion of the module Mb is preferably a cuboid except for the convex portions c and the concave portions.

The four convex portions c of the module Mb can be connected to the four concave portions of another module Mb. By displacing and connecting the module Mb and another module Mb, one or a plurality of convex portion (s) and concave portion (s) may be connected. By connecting the convex portion c of the module Mb and the concave portion of another module Mb, the connection port p of the convex portion c and the connection port p of the concave portion are connected.

The shape of the module is not limited to the above example. For example, when a physical model created by a plurality of modules is a home electronics or a gadget, modules of more complex shapes may be adopted according to a shape of the physical model.

Further, an electrical and mechanical connection shape of the module is not limited to the above example. For example, a method such as a USB connector which can be electrically and mechanically connected by way of plugging or a D-SUB (a connector used for display connection) which is electrically and mechanically connected by way of plugging and screwing may be adopted as a method of simultaneously establishing electrical connection and mechanical connection similar to the above example.

(Schematic Configuration of First Embodiment)

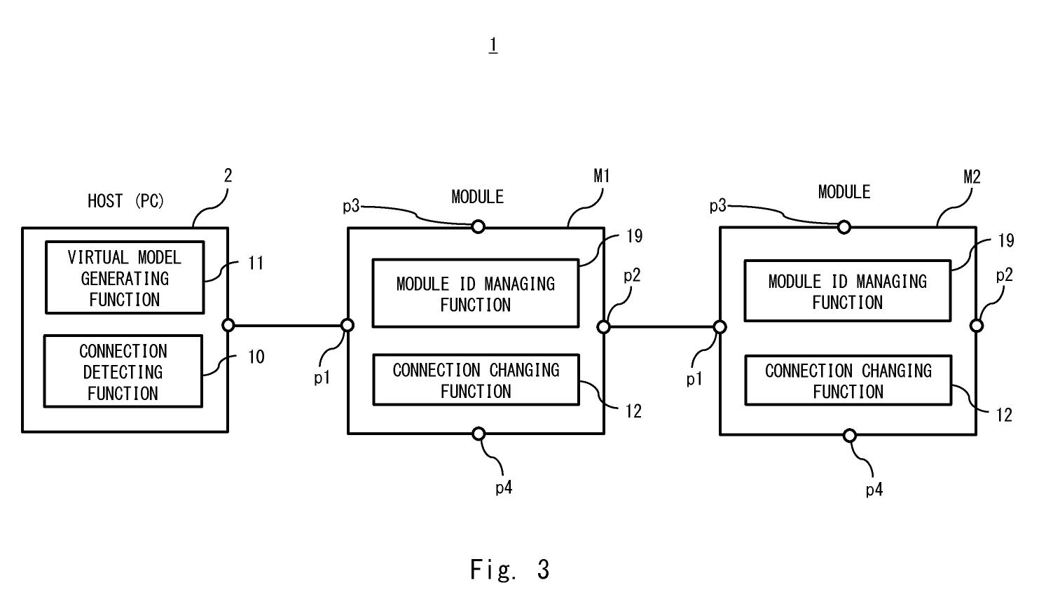

Next, a schematic configuration of a virtual model generating system 1 according to the first embodiment will be described with reference to FIG. 3. As illustrated in FIG. 3, the virtual model generating system 1 includes a host 2 and a plurality of modules M1 and M2. Hereinafter, an example where the two modules M1 and M2 form a physical model will be described. However, the number of modules is not limited to this. Further, modules M1, M2, . . . and Mn (n is a positive integer equal to or more than 2) will be also referred to as “modules M” unless distinguished in particular.

The host 2 is connected with the module M1. The module M1 is connected with the module M2. The host 2 can communicate with the module M1. Further, the host 2 can communicate with the module M2 through the module M1.

The host 2 includes a connection detecting function 10 and a virtual model generating function 11. The connection detecting function 10 detects a connection relation of a plurality of modules M1 and M2 by communicating with each of a plurality of modules M1 and M2. The virtual model generating function 11 generates a virtual model which represents the physical model composed by a plurality of modules M1 and M2 based on the connection relation of a plurality of modules M1 and M2 detected by the connection detecting function 10.

Each of the modules M1 and M2 includes a connection changing function 12, a module ID managing function 19 and a plurality of connection ports p1 to p4. The connection changing function 12 changes a connection state of a plurality of connection ports p1 to p4 inside the modules M1 and M2. The module ID managing function 19 holds module IDs. Each module ID is information which uniquely indicates a module. Hence, a module ID included in the module ID managing function 19 of the module M1 and a module ID included in the module ID managing function 19 of the module M2 are different. In addition, an example where the modules M1 and M2 include the four connection ports p1 to p4 will be described below. However, the number of connection ports included in each module M is not limited to this. Further, connection ports p1, p2, . . . and pn (n is a positive integer equal to or more than 2) will be also referred to as a “connection port p” unless distinguished in particular.

The connection detecting function 10 can request each of the modules M1 and M2 to change the connection states of a plurality of connection ports p1 to p4 inside each of the modules M1 and M2. The connection changing function 12 of each of the modules M1 and M2 changes connection states of the connection ports p1 to p4 in response to the request from the connection detecting function 10.

In this regard, the host 2 and the connection port p1 of the module M1 are connected. That is, the host 2 and the module M1 are electrically connected. Hence, the host 2 can communicate with the module M1. Further, the connection port p2 of the module M1 and the connection port p1 of the module M2 are connected. That is, the module M1 and the module M2 are electrically connected.

Hence, when the connection port p1 and the connection port p2 are connected inside the module M1, the host 2 is connected with the module M2 through the module M1. That is, the host 2 is electrically connected with the module M2. Consequently, the host 2 can communicate with the module M2 in this case. Meanwhile, when the connection port p1 and the connection port p2 are not connected inside the module M1, the host 2 is not connected with the module M2. That is, the host 2 and the module M2 are electrically disconnected. Hence, the host 2 cannot communicate with the module M2 in this case.

Thus, when the connection ports p1 and p2 are connected inside the module M1, the host 2 can communicate with both of the module M1 and the module M2. Meanwhile, when the connection ports p1 and p2 are not connected inside the module M1, the host 2 can communicate with the module M1 yet cannot communicate with the module M2. That is, whether or not the host 2 and the module M2 connected via the module M1 can communicate depends on the connection state of the connection port p1 and p2 inside the module M1. In other words, when the connection ports p1 and p2 are connected inside the module M1 and communication can be newly performed with the module M2, the module M2 corresponds to a module connected via the module M1.

Thus, the connection detecting function 10 can detect a connection relation of the modules M1 and M2 based on a change in the connection states of the connection ports p1 to p4 inside each of the modules M1 and M2 and a change as to whether or not communication can be performed with each of the modules M1 and M2.

Whether communication can be performed with each of the modules M1 and M2 is determined based on whether or not the connection detecting function 10 can acquire the module ID of each of the modules M1 and M2 from each of the modules M1 and M2. Hence, a change as to whether or not communication can be performed with each of the modules M1 and M2 can be detected by detecting a change in the number of module IDs acquired by the connection detecting function 10. That is, when the connection ports p1 and p2 inside the module M1 are not connected, the connection detecting function 10 can communicate with the module M1 yet cannot communicate with the module M2. Hence, the connection detecting function 10 can acquire the module ID of the module M1 from the module M1 yet cannot acquire the module ID of the module M2 from the module M2. Meanwhile, when the connection ports p1 and p2 are connected inside the module M1, the connection detecting function 10 can communicate with both of the module M1 and the module M2. Consequently, the connection detecting function 10 can acquire the module IDs of the module M1 and the module M2 from both of the module M1 and the module M2.

Hence, the connection detecting function 10 determines that the module M1 is connected with the module M2 when the module ID of the module M2 is newly acquired by connecting the connection ports p1 and p2 inside the module M1.

Thus, in the first embodiment, the host 2 detects the module M2 newly recognized through the module M1 as the module M2 to be connected to the module M1 by connecting the connection ports p1 and p2 inside the module M1.

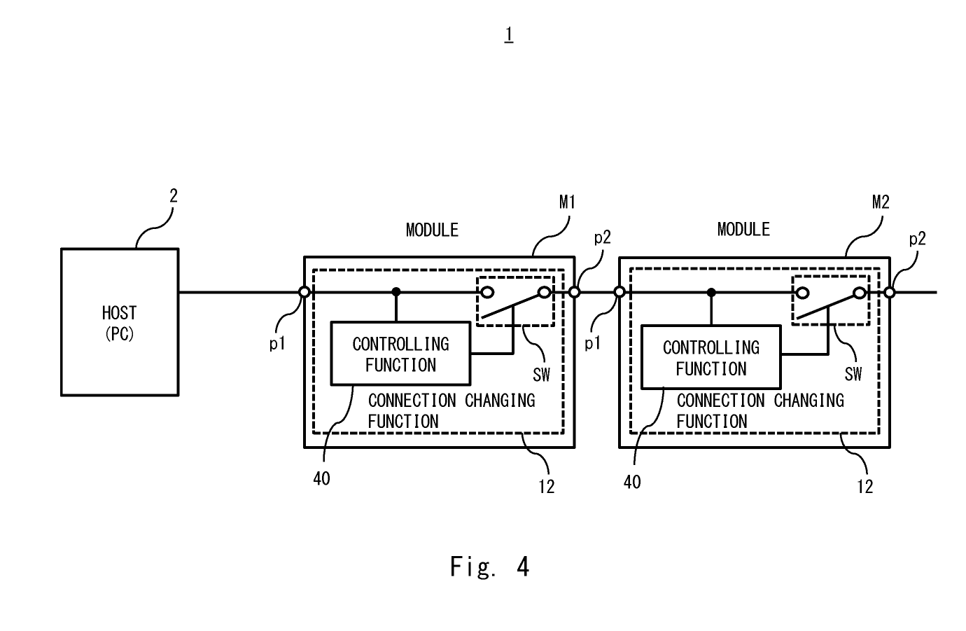

Next, a schematic configuration of the connection changing function 12 according to the first embodiment will be described with reference to FIG. 4. As illustrated in FIG. 4, the connection changing function 12 of each of the modules M1 and M2 includes a controlling function 40 and a switch SW. In addition, an example where each of the modules M1 and M2 includes the two connection ports p1 and p2 will be described with reference to FIG. 4.

The controlling function 40 switches the switch SW to on or off in response to a request from the host 2. The switch SW is provided between the connection port p1 and the connection port p2. When switched to on by the controlling function 40, the switch SW electrically connects the connection port p1 and the connection port p2. When switched to off by the controlling function 40, the switch SW electrically disconnects the connection port p1 and the connection port p2.

The host 2 transmits a connection change command which is information for requesting each of the modules M1 and M2 to change a connection state of the connection ports p1 and p2. This connection change command requests connection of the connection ports p1 and p2 or requests disconnection of the connection ports p1 and p2.

The controlling function 40 changes the connection state of the connection ports p1 and p2 according to the connection change command from the host 2. That is, the controlling function 40 switches the switch SW to on and connects the connection ports p1 and p2 according to the connection change command for requesting connection of the connection ports p1 and p2. Meanwhile, the controlling function 40 switches the switch SW to off and disconnects the connection ports p1 and p2 according to the connection change command for requesting disconnection of the connection ports p1 and p2.

In this regard, in the first embodiment, when the switch SW of each of the modules M1 and M2 is switched to on, and all modules are connected, the connection port p1 and the connection port p2 are simply short-circuited and therefore all modules M1 and M2 are connected to one bus. Hence, the host 2 can determine that the modules M1 and M2 are connected, yet cannot determine whether or the directly connected module M is the module M1 or the module M2.

Hence, in the first embodiment, the host 2 first switches the switches SW of all modules M1 and M2 to off. In addition, the switch SW of each of the modules M1 and M2 may be switched to off in advance. In this state, the host 2 can recognize that the module M directly connected to the host 2 is the module M1. Next, the host 2 transmits to the module M1 the connection change command for requesting connection of the connection ports p1 and p2. The module M1 switches the switch SW to on and connects the connection ports p1 and p2. Hence, the host 2 can newly communicate with the module M2 through the module M1. Hence, the host 2 can recognize that the module M2 is connected via the module M1.

In the first embodiment, a connection relation of a plurality of modules M1 and M2 is recognized by connecting the modules M1 and M2 one by one according to the above operation.

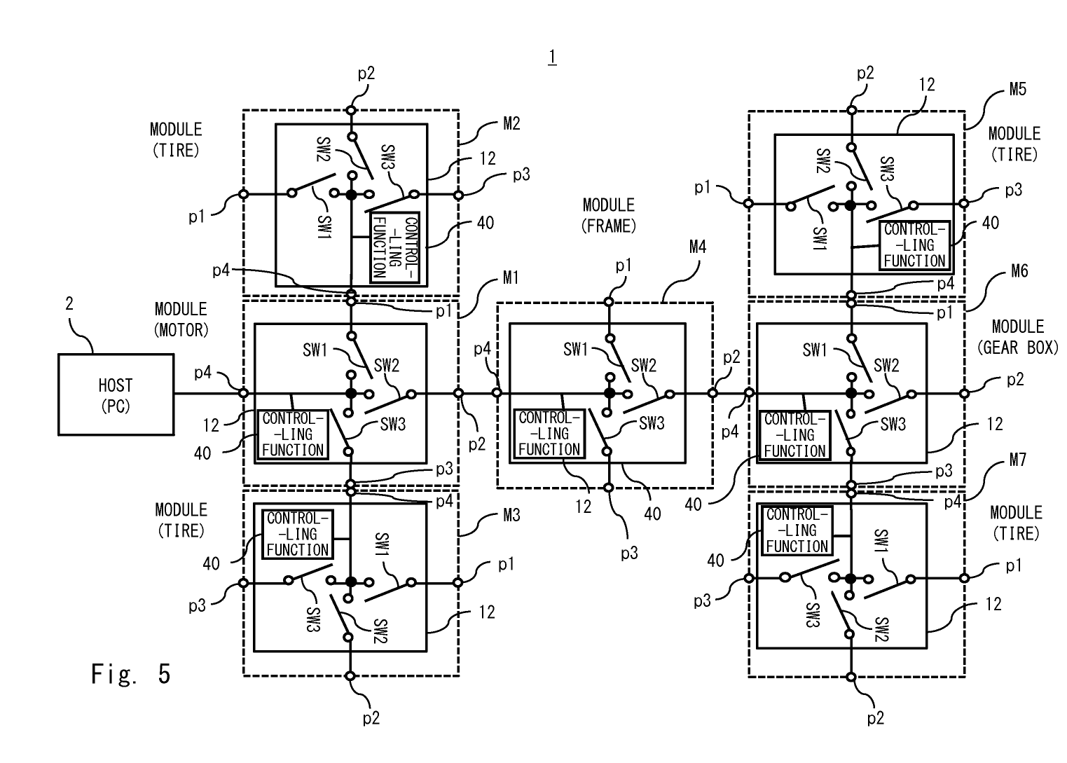

Next, an example where the modules M according to the first embodiment are connected in a more complex manner will be described with reference to FIG. 5. In the example illustrated in FIG. 5, the virtual model generating system 1 includes the host 2 and a plurality of modules M1 and M7.

FIG. 5 illustrates an example where a car is assembled as a gadget which is operated by the modules M1 to M7. The module M1 functions as a motor. The modules M2, M3, M5 and M7 function as tires. The module M4 functions as a frame. The module M6 functions as a gear box.

The module M1 is connected with the module M2 which functions a rear left wheel and the module M3 which functions as a rear right wheel. The module M4 has a rear portion connected with the module M1 and a front portion connected with the module M6. The module M6 is connected with the module M5 which functions a front left wheel and the module M7 which functions as a front right wheel.

In FIG. 5, each of the modules M1 to M7 includes the four connection ports p1 to p4, and three switches SW1 to SW3. Each of the switches SW1 to SW3 corresponds to each of the connection ports p1 to p3. In addition, switches SW1, SW2, . . . and SWn (n is a positive integer equal to or more than 2) will be also referred to as “switches SW” unless distinguished in particular.

The switch SW1 is provided between the connection port p4 and the connection port p1. When switched to on by the controlling function 40, the switch SW1 electrically connects the connection port p4 and the connection port p1. When switched to off by the controlling function 40, the switch SW1 electrically disconnects the connection port p4 and the connection port p1.

The switch SW2 is provided between the connection port p4 and the connection port p2. When switched to on by the controlling function 40, the switch SW2 electrically connects the connection port p4 and the connection port p2. When switched to off by the controlling function 40, the switch SW2 electrically disconnects the connection port p4 and the connection port p2.

The switch SW3 is provided between the connection port p4 and the connection port p3. When switched to on by the controlling function 40, the switch SW3 electrically connects the connection port p4 and the connection port p3. When switched to off by the controlling function 40, the switch SW3 electrically disconnects the connection port p4 and the connection port p3.

The connection port p1 of the module M1 is connected with the connection port p4 of the module M2. The connection port p2 of the module M1 is connected with the connection port p4 of the module M4. The connection port p3 of the module M1 is connected with the connection port p4 of the module M3. The connection port p4 of the module M1 is connected with the host 2.

The connection ports p1 to p3 of the module M2 are not connected with the other modules M. The connection ports p1 to p3 of the module M3 are not connected with the other modules.

The connection port p2 of the module M4 is connected with the connection port p4 of the module M6. The connection ports p1 and p3 of the module M4 are not connected with the other modules M.

The connection port p1 of the module M6 is connected with the connection port p4 of the module M5. The connection port p2 of the module M6 is not connected with the other modules M. The connection port p3 of the module M6 is connected with the connection port p4 of the module M7.

The connection ports p1 to p3 of the module M5 are not connected with the other modules M. The connection ports p1 to p3 of the module M7 are not connected with the other modules M.

Next, a process of checking a connection relation of the modules M1 to M7 connected in this way will be described. First, similar to the above, the host 2 first switches all switches SW1 to SW3 of all modules M1 to M7 to off.

The host 2 is connected with the module M1, and can communicate with the module M1. Consequently, the host 2 can recognize the module M1. When recognizing the module M1, the host 2 switches the switches SW1 to SW3 of the module M1 to on in order of the switch SW1, the switch SW2 and the switch SW3.

When switching the switch SW1 of the module M1 to on, the host 2 is connected with the module M2 and can communicate with the module M2. That is, the host 2 newly recognizes the module M2 as the module M to be connected with the module M1. When recognizing the module M2, the host 2 switches the switches SW1 to SW3 of the module M2 to on in order of the switch SW1, the switch SW2 and the switch SW3.

However, the connection ports p1 to p3 of the module M2 are not connected with the other modules M, and therefore the host 2 cannot recognize a new module when switching the switches SW1 to SW3 of the module M2 to on.

Hence, the host 2 returns an object which operates the switches SW to the module M1, and switches the next switch SW2 to on. When switching the switch SW2 to on, the host 2 is connected with the module M4 and can communicate with the module M4. That is, the host 2 recognizes the new module M4. When recognizing the module M4, the host 2 switches the switches SW1 to SW3 of the module M4 to on in order of the switch SW1, the switch SW2 and the switch SW3.

The host 2 cannot recognize the new module M when switching the switch SW1 of the module M4 to on, and is connected with the module M6 and can communicate with the module M6 when switching the switch SW2 to on next. That is, the host 2 newly recognizes the module M6 as the module M to be connected to the module M4. The host 2 switches the switches SW1 to SW3 of the module M6 to on in order of the switch SW1, the switch SW2 and the switch SW3 when recognizing the module M6.

The host 2 is connected with the module M5 and can communicate with the module M5 when switching the switch SW1 of the module M6 to on. That is, the host 2 newly recognizes the module M5 as the module M to be connected to the module M6. The host 2 switches the switches SW1 to SW3 of the module M5 to on in order of the switch SW1, the switch SW2 and the switch SW3 when recognizing the module M5.

However, the connection ports p1 to p3 of the module M5 are not connected with the other modules M, and therefore, the host 2 cannot recognize the new module M even when switching one of the switches SW1 to SW3 of the module M5 to on.

Hence, the host 2 returns an object which operates the switch SW, to the module M6, and switches the new switch SW2 to on. The host 2 cannot recognize the new module M when switching the switch SW2 to on, yet is connected with the module M7 and can communicate with the module M7 when switching the switch SW3 to on next. That is, the host 2 newly recognizes the module M7 as the module M to be connected to the module M6. The host 2 switches the switches SW1 to SW3 of the module M7 to on in order of the switch SW1, the switch SW2 and the switch SW3 when recognizing the module M7.

However, the connection ports p1 to p3 of the module M7 are not connected with the other modules M, and therefore the host 2 cannot recognize the new module M even when switching one of the switches SW1 to SW3 to on.

Hence, the host 2 returns an object which operates the switches SW, to the module M6 yet the module M6 has already switched all switches SW1 to SW3 to on. Hence, the host 2 further returns an object which operates the switches SW, to the module M4 and switches the switch SW3 to on next yet cannot recognize the new module M. Hence, the host 2 further returns an object which operates the switches SW, to the module M1 and switches the next switch SW3 to on.

The host 2 is connected with the module M3 and can communicate with the module M3 when switching the switch SW3 to on. That is, the host 2 recognizes the new module M3 as the module M to be connected to the module M1. The host 2 switches the switches SW1 to SW3 of the module M3 to on in order of the switch SW1, the switch SW2 and the switch SW3 when recognizing the module M3.

However, the connection ports p1 to p3 of the module M3 are not connected with the other modules M, and therefore the host 2 cannot recognize the new module M even when switching one of the switches SW1 to SW3 of the module M7 to on.

Hence, the host 2 returns an object which operates the switches SW, to the module M1 yet the module M6 has already switched all switches SW1 to SW3 to on. Hence, the host 2 finishes checking a connection relation of the modules M1 to M7. Thus, by checking with which module M communication can be newly established when the switches SW1 to SW3 of each of the modules M1 to M7 are recursively switched to on one by one, it is possible to recognize the connection relation of the modules M1 to M7.

(Schematic Operation of First Embodiment)

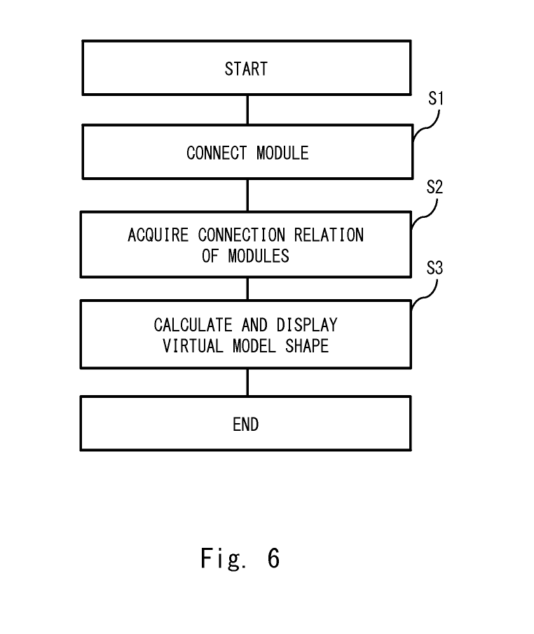

Next, the schematic operation of the virtual model generating system 1 according to the first embodiment will be described with reference to FIG. 6.

A user creates a physical model by connecting a plurality of modules to each other (S1). The connection detecting function 10 of the host 2 acquires a connection relation of a plurality of modules M which compose the physical model (S2). The virtual model generating function 11 of the host 2 calculates a shape of the virtual model based on the connection relation of a plurality of modules M acquired by the connection detecting function 10, and displays the calculated shape of the virtual model (S3).

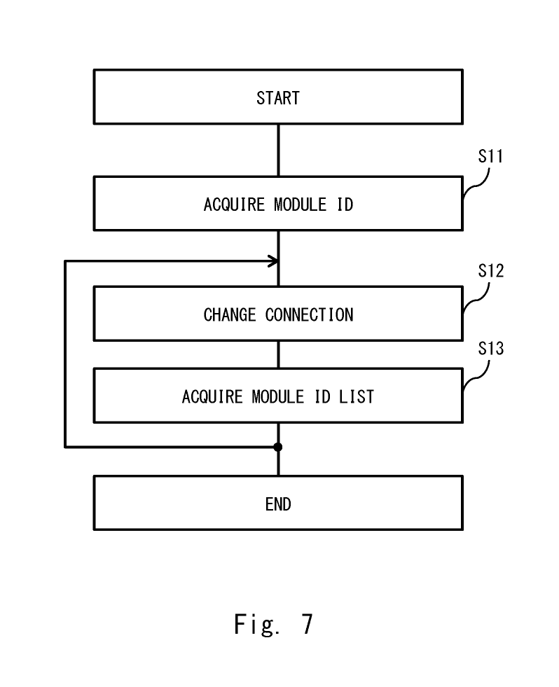

Next, a schematic operation of connection relation acquisition processing of the virtual model generating system 1 according to the first embodiment of the present invention will be described with reference to FIG. 7.

First, the connection detecting function 10 of the host 2 acquires a module ID list (S11). First, all connection ports p of all modules M are disconnected, and therefore only a module ID of the module M1 directly connected to the host 2 is acquired. Hereinafter, the connection detecting function 10 of the host 2 repeats processing in steps S12 and S13 described next until processing is executed with respect to all switches SW of all modules M. The connection detecting function 10 switches the switches SW of the modules M to on and connects the connection ports p (S12). The connection detecting function 10 acquires the module ID list (S13). That is, the connection detecting function 10 acquires module IDs from all modules M to be connected with the host 2. Consequently, when detecting a new module ID, the connection detecting function 10 can detect the module M specified based on this module ID as the module M to be connected to the module M which has operated the switches SW.

According to a technique disclosed in Japanese Unexamined Patent Application Publication No. 2003-132373, each component needs a highly sensitive radio signal sensor which can detect a fine distance difference, and a highly functional controller which includes a CPU which can execute complex algorithms. Hence, there is a problem that a system of each component is highly costly and consumes high power.

By contrast with this, in the first embodiment, only the switches SW and a control circuit (controlling function) which controls the switches SW need to be mounted on each module M. Consequently, it is possible to substantially simplify the configuration of the module M, and substantially reduce cost and power consumption of the module M and the system.

According to a technique of measuring a distance by a radio signal, it is necessary to measure an intensity of the radio signal to measure the distance. Hence, a highly sensitive wireless IC (Integrated Circuit) is necessary to accurately measure a distance, and a price of a microcontroller having the wireless IC mounted thereon is about 1000 yen each. Meanwhile, in the first embodiment, only a microcomputer including a wired communication function is sufficient, so that a price of the microcontroller having the wired communication function mounted thereon is 100 yen or less and it is possible to reduce the price to about 1/10.

(Detailed Configuration of First Embodiment)

Hereinafter, the virtual model generating system 1 according to the first embodiment will be described in more detail.

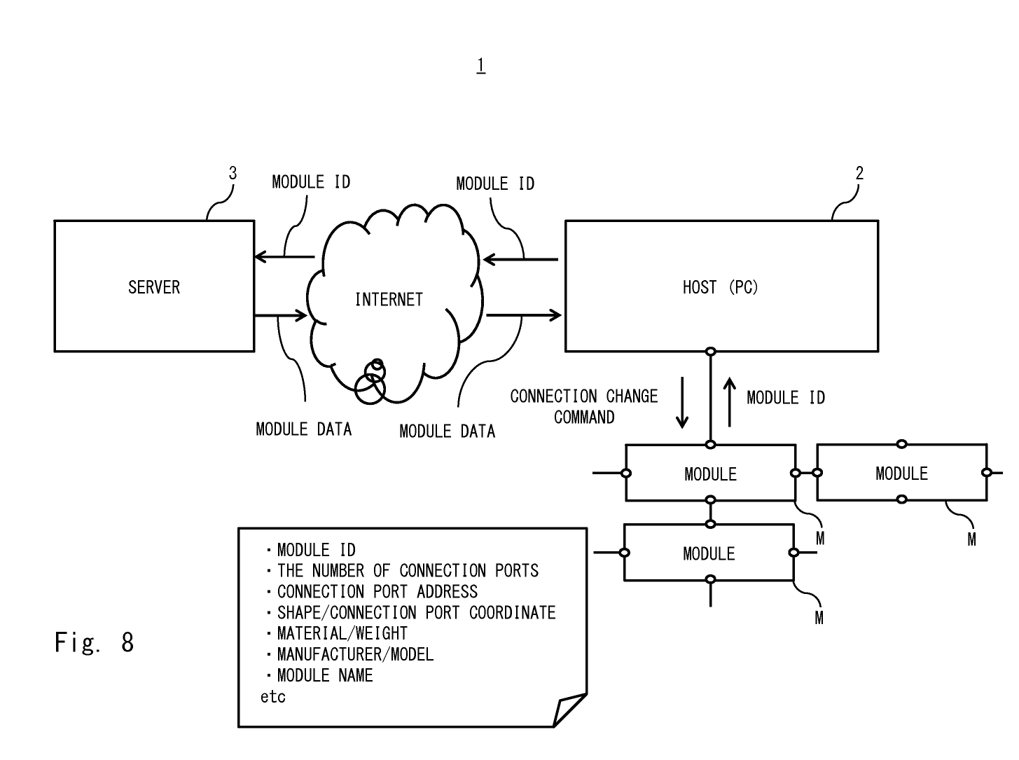

First, a configuration of the virtual model generating system 1 according to the first embodiment will be described with reference to FIG. 8. As illustrated in FIG. 8, the virtual model generating system 1 includes the host 2, a server 3 and a plurality of modules M.

As described above, a plurality of modules M are connected to each other. The host 2 is connected to one of a plurality of modules M. The host 2 is connected with the server 3 through the Internet.

The host 2 recognizes the connection relation of a plurality of modules M by repeatedly transmitting a connection change command to the modules M and acquiring module IDs as described above. In this regard, when detecting the new module M, the host 2 inquires the server 3 of various pieces of information of this module M. The server 3 provides to the host 2 module data which is the various pieces of information of this module M in response to the inquiry from the host 2.

More specifically, the host 2 transmits to the server 3 data request information for requesting transmission of the module data as the inquiry about the various pieces of the module. This data request information includes a module ID of the module M newly detected by the host 2. That is, the host 2 inquires the server 3 of the various pieces of information of the module M by using the module ID as a key. The server 3 transmits to the host 2 the module data of the module M specified based on the module ID included in this data request information in response to the data request information from the host 2. This module data indicates a module ID, the number of connection ports, a connection port address, a module shape, a connection port coordinate, a material/weight, a manufacturer/model and a module name.

The host 2 calculates a coordinate and a posture of each module M based on the connection relation of a plurality of modules M recognized by the host 2 and the module data acquired from the server 3. Further, the host 2 finally displays a three-dimensional shape of the virtual model.

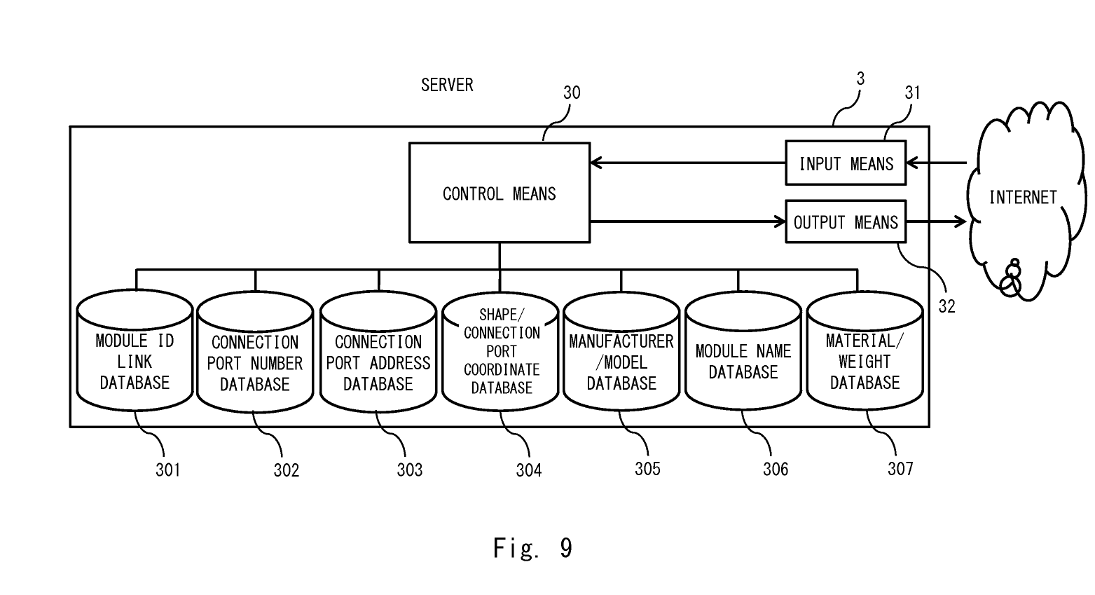

Next, a configuration of the server 3 according to the first embodiment will be described with reference to FIG. 9. As illustrated in FIG. 9, the server 3 includes control means 30, input means 31 and output means 32. Further, in the server 3, a module ID linking database 301, a connection port number database 302, a connection port address database 303, a shape/connection port coordinate database 304, a manufacturer/model database 305, a module name database 306 and a material/weight database 307 are stored in advance.

The control means 30 integrally controls the server 3. The control means 30 collects various pieces of information of the module M specified based on a module ID in response to an inquiry made by from the host 2 by using the module ID as a key. The control means 30 provides the collected various pieces of information as module data to the host 2 through the output means 32.

The input means 31 receives the information transmitted from the host 2, and outputs the information to the control means 30. The output means 32 transmits the information outputted from the control means 30, to the host 2.

The module ID linking database 301 is information for linking a module ID and information corresponding to this module ID in the databases 302 to 306. That is, by acquiring the information corresponding to the module ID from the databases 302 to 306, various pieces of the module M specified based on this module ID are acquired.

The connection port number database 302 is information indicating the number of connection ports of each module M. More specifically, the connection port number database 302 is information indicating a list of numbers of connection ports which a plurality of modules M can take. When types of the modules Mare the same, the numbers of connection ports are the same between these modules M. Meanwhile, when types of the modules M are different, the numbers of connection ports may be different between these modules M. The connection port number database 302 indicates a list of the numbers of connection ports to cover all different numbers of connection ports.

The connection port address database 303 is information indicating an address (register value) of each connection port p included in each module M. More specifically, the connection port number database 302 is information indicating a list of combinations of addresses of the connection ports p which a plurality of modules M take. In this regard, each combination of addresses of connection ports means an address of one connection port p when the number of connection ports of the module M is one, and means addresses of two or more connection ports p when the number of connection ports of the module M is two or more. When types of the modules M are the same, combinations of addresses of the connection ports p included in these modules M are the same. Meanwhile, when types of the modules M are different, combinations of addresses of the connection ports p included in these modules M may be different in some cases. The connection port number database 302 indicates a list of combinations of addresses of connection ports to cover all different combinations.

The shape/connection port coordinate database 304 is information indicating a shape of each module M and a coordinate of each connection port p of each module M. More specifically, the shape/connection port coordinate database 304 is information indicating a list of pairs of the shape of each module M and the coordinate of each connection port p. In this regard, the coordinate of each connection port p means the coordinate of one connection port p when the number of connection ports of the module M is one, and means coordinates of the two or more connection ports p when the number of connection ports of the module M is two or more. When types of the modules M are the same, shapes of these modules M and coordinates of the connection ports p of these modules Mare the same. Meanwhile, when types of the modules Mare different, shapes of these modules M and coordinates of the connection ports p of these modules M may be different in some cases. The shape/connection port coordinate database 304 indicates a list of pairs of shapes and coordinates of the connection ports p to cover all different pairs of shapes and coordinates of the connection ports.

The manufacturer/model database 305 is information indicating a manufacturer of each module M and a model of each module M. More specifically, the manufacturer/model database 305 is information indicating a list of pairs of manufacturers and models of the modules M. When types of the modules M are the same, manufacturers of these modules M are the same. Meanwhile, when types of the modules M are different, manufacturers of these modules M may be different in some cases. When types of the modules M are the same, models of these modules M are the same. Meanwhile, when types of the modules M are different, models of these modules M are different. The manufacturer/model database 305 indicates a list of pairs of manufacturers and models to cover all different pairs of manufacturers and models.

The module name database 306 is information indicating a module name of each module M. More specifically, the module name database 306 is information indicating a list of modules names of the modules M. When types of the modules M are the same, modules names of these modules M are the same. Meanwhile, when types of the modules M are different, module names of these modules M are different. The module name database 306 indicates a list of module names to cover all different module names.

The material/weight database 307 is information indicating a material of each module M and a weight of each module M. More specifically, the material/weight database 307 is information indicating a list of pairs of materials and weights of the modules M. When types of the modules M are the same, materials and weights of these modules M are the same. Meanwhile, when types of the modules M are different, materials and weights of these modules Mare different. The material/weight database 307 indicates a list of pairs of materials and weights to cover all different pairs of materials and weights.

In addition, an example where shapes and connection port coordinates are indicated by the same database 304, manufacturers and models are indicated by the same database 305 and materials and weights are indicated by the same database 307 has been described above. However, a configuration of a database stored in the server 3 is not limited to this. For example, shapes and connection port coordinates may be indicated by different databases, manufacturers and models may be indicated by different databases, or materials and weights may be indicated by different databases. Further, pieces of information indicated by different databases in the above example may be indicated by the same database.

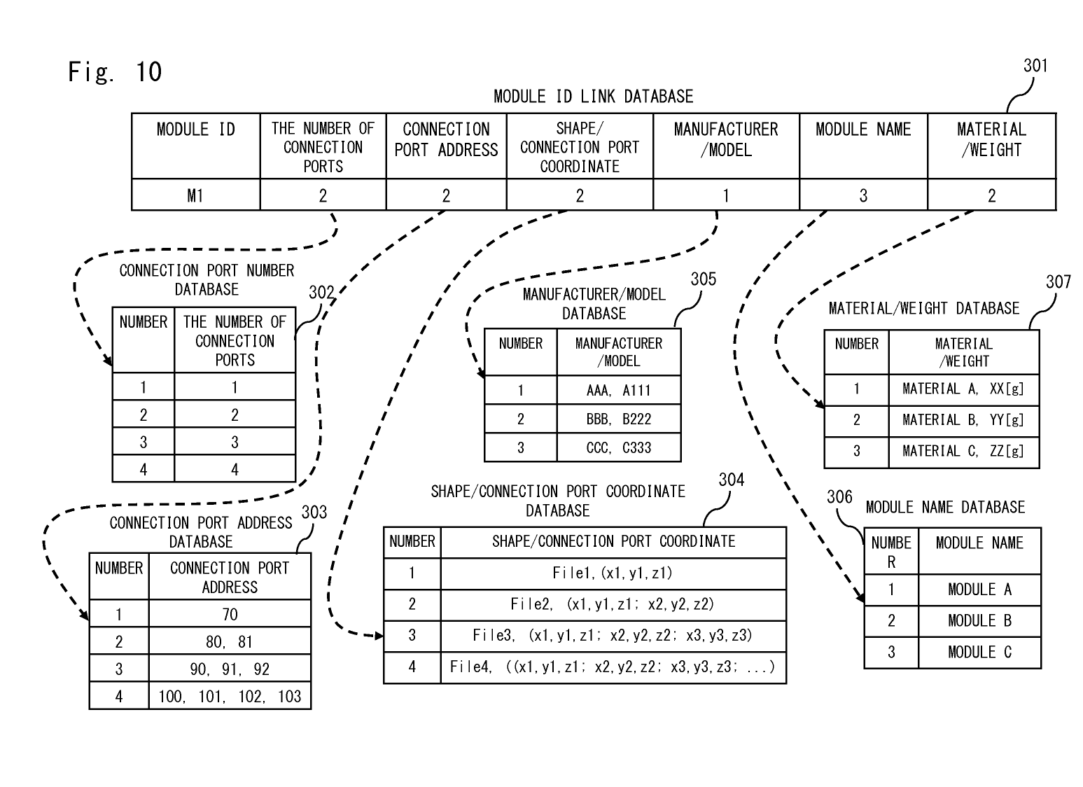

Next, an operation of acquiring various pieces of information of a module in the server 3 according to the first embodiment will be described with reference to FIG. 10.

As illustrated in FIG. 10, the module ID linking database 301 links a module ID of each module M and information corresponding to this module ID in each of the databases 302 to 307. More specifically, the module ID linking database 301 indicates a pair of a module ID and identification information for specifying one of pieces of information in each of the databases 302 to 307. FIG. 10 illustrates an example where identification information is an identification number uniquely allocated to each of a plurality of pieces indicated as a list in each of the databases 302 to 307. As illustrated in, for example, FIG. 10, this identification number may be a row number of a table when each of the databases 302 to 307 indicates a list of a plurality of pieces of information as the table. In addition, in the example in FIG. 10, the module ID linking database 301 indicates only one module ID for simplification of description.

In the example in FIG. 10, in the module ID linking database 301, a module ID “M1”, an identification number “2” of the connection port number database 302, an identification number “2” of the connection port address database 303, an identification number “2” of the shape/connection port coordinate port coordinate database 304, an identification number “1” of the manufacturer/model database 305, an identification number “3” of the module name database 306, and an identification number “2” of the material/weight database 307 are linked.

Hence, the control means 30 of the server 3 acquires information indicating the number of connection port “2” as information specified based on the identification number “2” from the connection port number database 302 in response to an inquiry made by the host 2 by using the module ID “M1” as a key. Further, the control means 30 acquires information indicating two connection port addresses “80 and 81” as information specified based on the identification number “2” from the connection port address database 303. Furthermore, the control means 30 acquires a pair of information “File 2” indicating a shape and information indicating coordinates “(x1, y1, z1, and x2, y2, z2)” of two connection ports as information specified based on the identification number “2” from the shape/connection port coordinate database 304. In this regard, the information “File 2” indicating the shape is, for example, an STL (Standard Triangulated Language) file. Thus, all or part of pieces of information acquired from each of the databases 302 to 307 may be acquired in file formats. Further, the control means 30 acquires a pair of information indicating a manufacturer “AAA” and information indicating a model “A111” as information specified based on the identification number “1” from the manufacturer/model database 305. Furthermore, the control means 30 acquires information indicating a module name “module C” as information specified based on an identification number “3” from the module name database 306. Still further, the control means 30 acquires a pair of information indicating a material “material B” and information indicating a weight “YY [g]” as information specified based on an identification number “2” from the material/weight database 307.

The control means 30 transmits to the host 2 the information acquired in this way as module data of the module M specified based on a module ID “M1”. Thus, the module ID linking database 301 links a module ID and various pieces of information of each module specified based on this module ID, so that it is possible to acquire various pieces of information of the module M from each of the databases 302 to 307 by using n the module ID as a key.

In this regard, a method of acquiring various pieces of information of each module by using a module ID as a key is not limited to this. For example, the server 3 may include information in which a module ID, the number of connection ports, a connection port address, a shape, a connection port coordinate, a manufacturer, a model, a module name, a material and a weight are associated instead of the above module ID linking database 301 and each of the databases 302 to 307. However, preferably, as described above, the server 3 may include the module ID linking database 301 and each of the databases 302 to 307. By so doing, the server 3 does not need to include pieces of same redundant information of the numbers of connection ports, connection port addresses, shapes, connection port coordinates, manufacturers, models, module names, materials and weights. Consequently, it is possible to reduce a consumption amount of a storage region in the server 3.

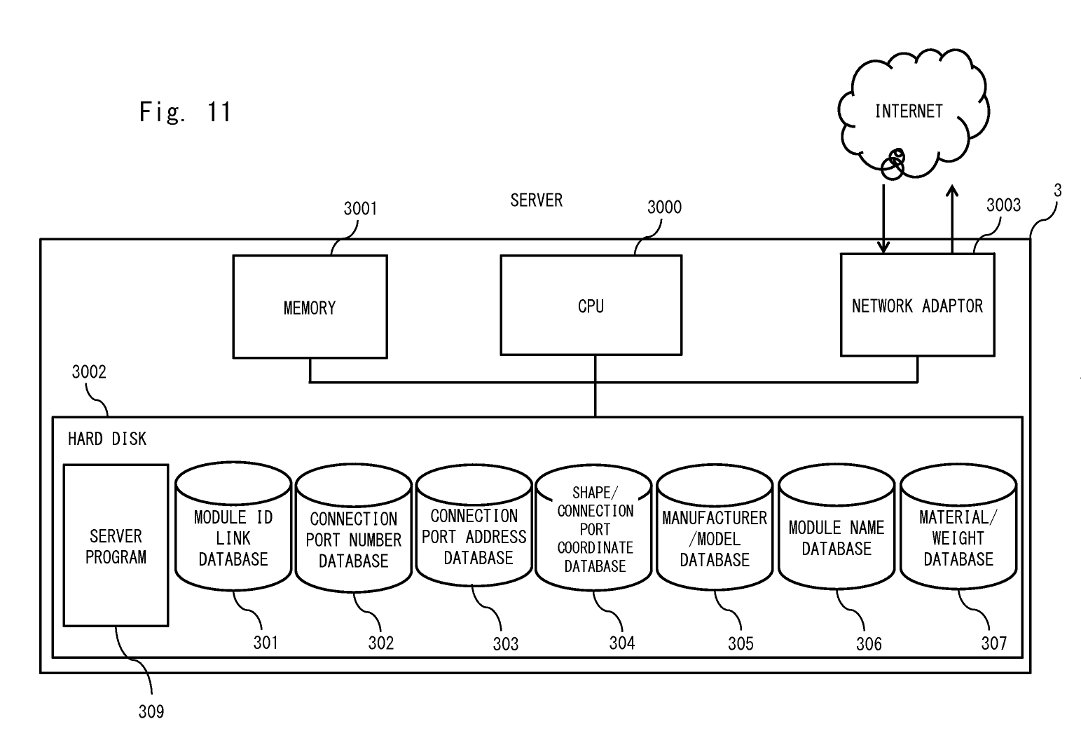

Next, a hardware configuration of the server 3 according to the first embodiment of the present invention will be described with reference to FIG. 11.

The server 3 includes a CPU 3000, a memory 3001, a hard disk 3002 and a network adaptor 3003.

The CPU 3000 integrally controls the server 3. The CPU 3000 executes various types of processing of the server 3 by loading a server program 309 stored in the hard disk 3002 to the memory 3001 and executing the server program 309. That is, the CPU 3000 and the memory 3001 function as the control means 30. In other words, the server program 309 includes a code for causing the CPU 3000 to execute processing of the control means 30. Further, the CPU 3000 loads to the memory 3001 part or all of the module ID linking database 301 and each of the databases 302 to 307 stored in the hard disk 3002 to refer to when necessary to execute various types of processing.

The memory 3001 temporarily stores information used by the CPU 3000. This information includes the module ID linking database 301, each of the databases 302 to 307 and the server program 309, too, as described above. The memory 3001 is a volatile storage device such as a DRAM (Dynamic Random Access Memory) or a SRAM (Static Random Access Memory).

In the hard disk 3002, the module ID linking database 301, each of the databases 302 to 307 and the server program 309 are stored in advance. In addition, in case of a non-volatile storage device such as the hard disk 3002, another storage device such as a flash memory may be adopted instead of the hard disk 3002. The memory 3001 and the hard disk 3002 function as storage means which store information used by the server 3. In addition, the number and a combination of storage devices which function as storage means are not limited to the above example, either.

The network adaptor 3003 converts information outputted from the CPU 3000, into a format which can be transmitted through the Internet, and transmits the information. Further, the network adaptor 300 receives information from the Internet, converts the information into a format which can be processed in the server 3 and outputs the information to the CPU 3000. The network adaptor 3003 functions as the input means 31 and the output means 32.

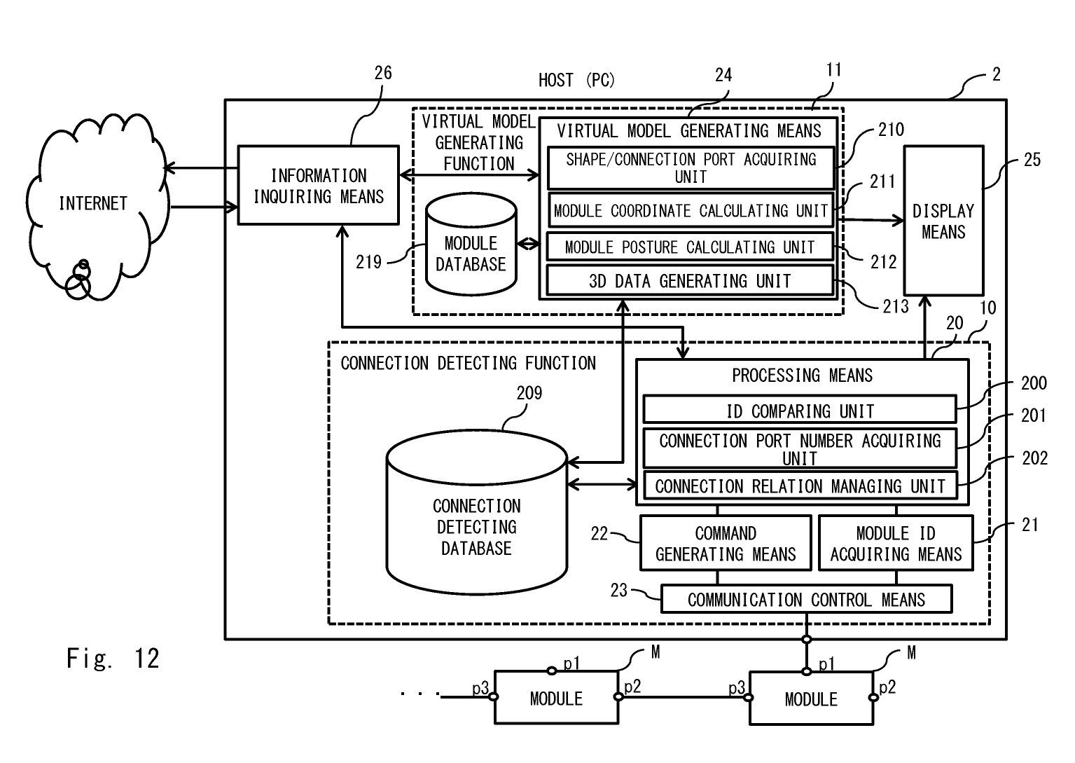

Next, a configuration of the host 2 according to the first embodiment will be described with reference to FIG. 12. As illustrated in FIG. 12, the host 2 includes the connection detecting function 10, the virtual model generating function 11, display means 25 and information inquiring means 26. The connection detecting function 10 includes processing means 20, module ID acquiring means 21, command generating means 22, communication control means 23 and a connection detecting database 209. The virtual model generating function 11 includes virtual model generating means 24 and a module database 219. That is, the host 2 includes the connection detecting database 209 and the module database 219.

The processing means 20 recognizes a connection relation of a plurality of modules M by communicating with each of a plurality of modules M, and constructs the connection detecting database 209 which indicates the recognized connection relation.

The module ID acquiring means 21 acquires a module ID list. The module ID acquiring means 21 acquires a list of module IDs of the module M to be connected with the host 2 by trying to acquire module IDs of all of a plurality of modules M. More specifically, the module ID acquiring means 21 transmits an ID return command which is information for requesting each of a plurality of modules M to return a module ID through the communication control means 23. The module ID acquiring means 21 receives ID information returned in response to the ID return command from each module M. This ID information indicates a module ID of this module M.

The command generating means 22 generates a connection change command for requesting a change of a connection state of the connection ports p inside the module M in response to a request from the processing means 20. More specifically, the processing means 20 specifies module M and the connection port p of this module M whose connection state is changed, and requests the command generating means 22 to change the connection state of the connection ports p in the module M. The command generating means 22 generates a command based on communication standards adopted for communication between the host 2 and each module M as a connection change command for requesting a change of the connection state of the connection port p of the module M specified by the processing means 20. The command generating means 22 transmits the generated connection change command through the communication control means 23. In addition, for the communication standards, arbitrary bus standards may be adopted from an I2C (Inter-Integrated Circuit), a USB (Universal Serial Bus), a RS435, a CAN (Controller Area Network), and an ISA (Industry Standard Architecture) and a FlexRay.

The communication control means 23 transmits information outputted from the module ID acquiring means 21 and the command generating means 22, to the module M. The communication control means 23 outputs the information transmitted from the module M, to the module ID acquiring means 21 and the command generating means 22.

In this regard, the processing means 20 includes an ID comparing unit 200, a connection port number acquiring unit 201 and a connection relation managing unit 202.

The ID comparing unit 200 compares a module ID list acquired this time by the module ID acquiring means 21 and a module ID list previously acquired by the module ID acquiring means 21. Thus, the ID comparing unit 200 detects as a new module ID a module which exists in the module ID list acquired this time by the module ID acquiring means 21 yet does not exist in the module ID list previously acquired by the module ID acquiring means 21. As described above, the ID comparing unit 200 detects the module M specified based on this newly detected module ID as the module to be connected to the module M which has lastly connected the connection ports p.

The connection port number acquiring unit 201 acquires the number of the module M from module data of the module M received by the information inquiring means 26 from the server 3 in response to an inquiry from the connection relation managing unit 202.

The connection relation managing unit 202 executes various types of processing of changing a connection state of connection ports in the module M and updating the connection detecting database 209 to construct the connection detecting database 209. The connection relation managing unit 202 updates the connection detecting database 209 to cause the connection detecting database 209 to indicate that the module M newly detected by the ID comparing unit 200 is connected to the module M connected to the module M which has lastly connected the connection ports p.

Further, the connection relation managing unit 202 inquires the server 3 of various pieces of information of the newly detected module M. That is, the connection relation managing unit 202 transmits data request information for requesting transmission of module data, to the server 3 through the information inquiring means 26. This inquiry is specified based on the newly detected module ID as a key. The connection relation managing unit 202 updates the connection detecting database 209 to cause the connection detecting database 209 to indicate that the number of connection ports of the newly detected module M acquired by the connection port number acquiring unit 201 is the number of connection ports of the newly detected module M in the connection relation of a plurality of modules M indicated by the connection detecting database 209.

The connection detecting database 209 is information indicating the connection relation of a plurality of modules M. The connection detecting database 209 is information as a connection relation of a plurality of modules M indicating how many connection ports p each module M includes, whether or not each of the connection port p is connected with the host 2 or another module M and with which module M the connection port is connected when the connection port p is connected with another module M.

The virtual model generating means 24 generates a virtual model which represents a physical model composed by a plurality of modules M based on a connection relation of a plurality of modules M detected by the connection detecting function 10.

In this regard, the virtual model generating means 24 includes a shape/connection port coordinate acquiring unit 210, a module coordinate calculating unit 211, a module posture calculating unit 212 and a 3D data generating unit 213.

The shape/connection port coordinate acquiring unit 210 stores module data of the newly detected module M received by the information inquiring means 26, in the module database 219. The shape/connection port coordinate acquiring unit 210 acquires a shape and a connection port coordinate of each of a plurality of modules M from each module data of a plurality of modules M upon generation of a virtual model.

The module coordinate calculating unit 211 calculates a coordinate of each of a plurality of modules M based on a shape and a connection port coordinate of each of a plurality of modules M acquired by the shape/connection port coordinate acquiring unit 210.

The module posture calculating unit 212 calculates a posture of each of a plurality of modules M based on the shape and the connection port coordinate of each of a plurality of modules M acquired by the shape/connection port coordinate acquiring unit 210.

The 3D data generating unit 213 generates a virtual model three-dimensionally indicating a shape of the physical model composed by a plurality of modules M based on a coordinate of each of a plurality of modules M calculated by the module coordinate calculating unit 211 and a posture of each of a plurality of modules M calculated by the module posture calculating unit 212. The 3D data generating unit 213 displays the generated virtual model on the display means 25.

The module database 219 stores module data of each of a plurality of modules M received from the server 3.

The display means 25 displays the virtual model generated by the 3D data generating unit 213. The display means 25 includes a display device which can display various images such as a virtual model. As a display device which functions as the display means, an arbitrary display such as a liquid crystal display, an organic EL display or a plasma display may be adopted. In addition, as described herein, the display device which functions as the display means 25 may be additionally provided in the virtual model generating system 1 such that the display device is connected with the host 2 without being integrated with the host 2.

The information inquiring means 26 transmits to the module M the information outputted from the processing means 20 and the virtual model generating means 24. The information inquiring means 26 outputs the information transmitted from the module M, to the processing means 20 and the virtual model generating means 24.

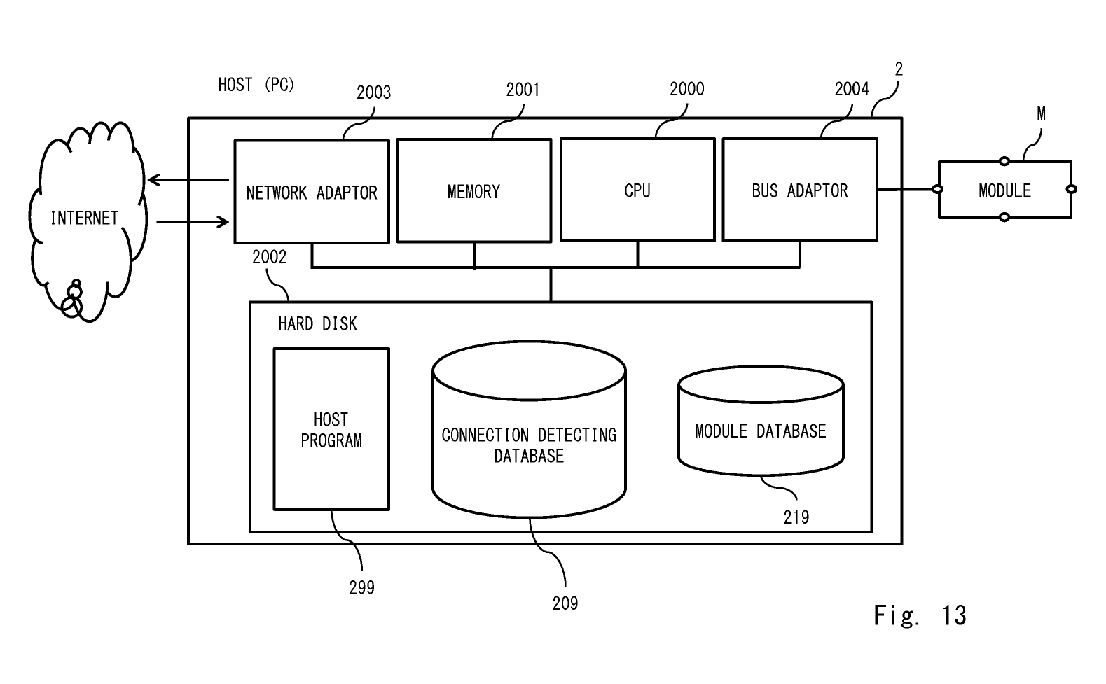

Next, a hardware configuration of the host 2 according to the first embodiment of the present invention will be described with reference to FIG. 13.

As illustrated in FIG. 13, the host 2 includes a CPU 2000, a memory 2001, a hard disk 2002, a network adaptor 2003 and a bus adaptor 2004.

The CPU 2000 integrally controls the host 2. The CPU 2000 executes various types of processing of the host 2 by loading a host program 299 stored in the hard disk 2002, to the memory 2001 and executing the host program 299. That is, the CPU 2000 and the memory 2001 function as the processing means 20, the module ID acquiring means 21, the command generating means 22, the virtual model generating means 24 and the information inquiring means 26. In other words, the host program 299 includes a code for causing the CPU 2000 to execute processing of the above means 20 to 22, 24 and 26. Further, the CPU 2000 loads the connection detecting database 209 and the module database 219 stored in the hard disk 2002, to the memory 2001 to refer to when necessary upon execution of the various types of processing.

The memory 2001 temporarily stores information used by the CPU 3000. This information includes the connection detecting database 209, the module database 219 and the host program 299 as described above. The memory 2001 is a volatile memory such as a DRAM or a SRAM.

In the hard disk 2002, the host program 299 is stored in advance. Further, in the hard disk 2002, the connection detecting database 209 and the module database 219 are constructed in response to execution of processing in the CPU 2000. In addition, in case of a non-volatile storage device such as the hard disk 2002, another storage device such as a flash memory may be adopted instead of the hard disk 2002. The memory 2001 and the hard disk 2002 function as storage means in which information used by the host 2 is stored. In addition, the number and a combination of storage devices which function as storage means are not limited to the above example.

The network adaptor 2003 converts information outputted from the CPU 2000 into a format which can be transmitted on the Internet, and transmits the information. Further, the network adaptor 2003 receives information from the Internet, converts the information into the format which can be processed in the host 2 and outputs the information to the CPU 2000. The network adaptor 2003 functions as the information inquiring means 26.

The bus adaptor 2004 converts the information outputted from the CPU 2000 into a format which can be transmitted through a bus constructed by connecting the host 2 and a plurality of modules M, and transmits the information. Further, the bus adaptor 2004 receives the information from the bus, converts the information into a format which can be processed in the host 2 and outputs the information to the CPU 2000. The bus adaptor 2004 functions as the communication control means 23.

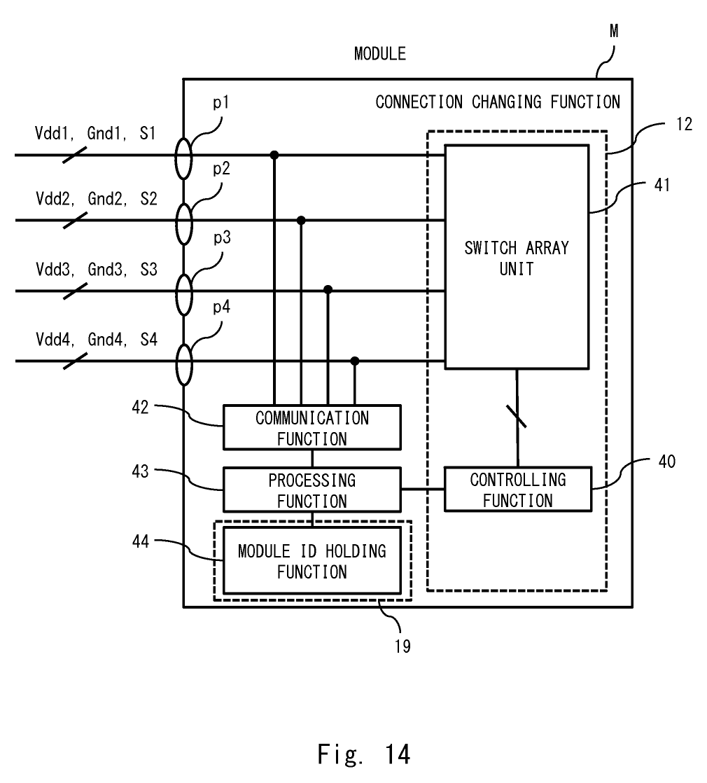

Next, a configuration of the module M according to the first embodiment will be described with reference to FIG. 14. As illustrated in FIG. 14, the module M includes the connection changing function 12, a communication function 42, a processing function 43, a module ID holding function 44 and at least one connection port p. The connection changing function 12 includes the controlling function 40 and a switch array unit 41. In addition, FIG. 14 illustrates an example where the number of connection ports is four of the connection ports p1 to p4. However, the number of connection ports is not limited to this.

Further, as illustrated in FIG. 14, the module M includes signal lines S1 to S4, power voltage lines Vdd1 to Vdd4 and ground lines Gnd1 to Gnd4. The numbers of the signal lines S1 to S4, the power voltage lines Vdd1 to Vdd4 and the ground lines Gnd1 to Gnd4 are the same as the numbers of connection ports p1 to p4. In addition, signal lines S1, S2, . . . and Sn (n is a positive integer equal to or more than 2) will be also referred to as “signal lines S” unless distinguished in particular. Further, the power supply voltage lines Vdd1, Vdd2, . . . and Vddn (n is a positive integer equal to or more than 2) will be also referred to as “power voltage lines Vdd” unless distinguished in particular. Furthermore, the ground lines Gnd1, Gnd2, . . . and Gndn (n is a positive integer equal to or more than 2) will be also referred to as “ground lines Gnd” unless distinguished in particular.

The signal line S1, the power voltage line Vdd1 and the ground line Gnd1 respectively connect the connection port p1, the switch array unit 41 and the communication function 42 with each other. The signal line S2, the power voltage line Vdd2 and the ground line Gnd2 respectively connect the connection port p2, the switch array unit 41 and the communication function 42 with each other. The signal line S3, the power voltage line Vdd3 and the ground line Gnd3 respectively connect the connection port p3, the switch array unit 41 and the communication function 42 with each other. The signal line S4, the power voltage line Vdd4 and the ground line Gnd4 respectively connect the connection port p4, the switch array unit 41 and the communication function 42 with each other.

The signal lines S1 to S4 configure the above bus when connected with the host 2. An arbitrary signal (information) is transmitted and received between the host 2 and each module M through the signal lines S1 to S4. This information is, for example, an ID return command and a connection change command as described above. When connected with the host 2, the power voltage lines Vdd1 to Vdd4 and the ground lines Gnd1 to Gnd4 supply power voltages for causing each module M to operate from the host 2.

The controlling function 40 controls the switch array unit 41 in response to a request from the processing function 43.

The communication function 42 converts the information outputted from the processing function 43 into a signal format which can be transmitted through the signal lines S1 to S4, and transmits the signal. Further, the communication function 42 receives signals through the signal lines S1 to S4, converts the signals into a format which can be processed in each module M and outputs the signals to the processing function 43.

The switch array unit 41 changes a connection state of the connection ports p1 to p4 in an arbitrary combination under control of the controlling function 40. As described above, the switch array unit 41 first disconnects all connection ports p1 to p4 from each other.

The processing function 43 executes various types of processing of returning ID information to the host 2 and controlling the switch array unit 41 according to the information received from the host 2 through the communication function 42. More specifically, the processing function 43 acquires ID information to be stored in the module ID holding function 44 in response to the ID return command received from the host 2, and transmits the acquired ID information to the host 2 through the communication function 42. Further, the processing function 43 requests the controlling function 40 to change a connection state of the connection ports p in response to the connection change command received from the host 2.

The module ID holding function 44 stores ID information indicated by a module ID of each module M in advance. The module ID holding function 44 includes a storage device which can store ID information. For this storage device, an arbitrary storage device may be adopted from storage devices such as a register and a memory.

When the connection port p1 is connected with the host 2 or another module M, the signal line S1, the power voltage line Vdd1 and the ground line Gnd1 of each module M are connected with the host 2 or the signal line S, the power voltage line Vdd and the ground line Gnd of another module M through the connection port p1. When the connection port p2 is connected with the host 2 or the another module M, the signal line S2, the power voltage line Vdd2 and the ground line Gnd2 of each module M are connected with the host 2 or the signal line S, the power voltage line Vdd and the ground line Gnd of another module M through the connection port p2. When the connection port p3 is connected with the host 2 or another module M, the signal line S3, the power voltage line Vdd3 and the ground line Gnd3 of each module M are connected with the host 2 or the signal line S, the power voltage line Vdd and the ground line Gnd of another module M through the connection port p3. When the connection port p4 is connected with the host 2 or another module M, the signal line S4, the power voltage line Vdd4 and the ground line Gnd4 of each module M are connected with the host 2 or the signal line S, the power voltage line Vdd and the ground line Gnd of another module M through the connection port p4.

Hence, when directly connected with the host 2 or indirectly connected with the host 2 through at least one another module M, the module M receives a supply of a signal, a power voltage and a ground voltage through the signal line S, the power voltage line Vdd and the ground line Gnd.

Hereinafter, a difference between the module M illustrated in FIG. 14 and the modules M1 and M2 illustrated in FIG. 4 will be described. In the modules M1 and M2 illustrated in FIG. 4, the signal line S from the connection port p1 at the host 2 side is directly connected to the controlling function 40, and the signal line S from the connection port p2 is connected to the controlling function 40 through the switch SW. Hence, when the connection port p1 is connected with the host 2 side, the host 2 can perform control to switch the switches SW of the modules M1 and M2 to on. However, when the connection port p2 is connected with the host 2 side, the host 2 cannot perform control to switch the switches SW of the modules M1 and M2 to on. When the switch SW is switched to off, it is not possible to control the controlling function 40 according to a connection change command given from the host 2 through the connection port p2.

Meanwhile, in the module M illustrated in FIG. 14, the signal lines S from all connection ports p1 to p4 are directly connected to the communication function 42 without the switch array unit 41. Consequently, even when the host 2 side is connected with any connection port p in the module M illustrated in FIG. 14, the processing function 43 can receive a connection change command from the host 2 through the communication function 42.

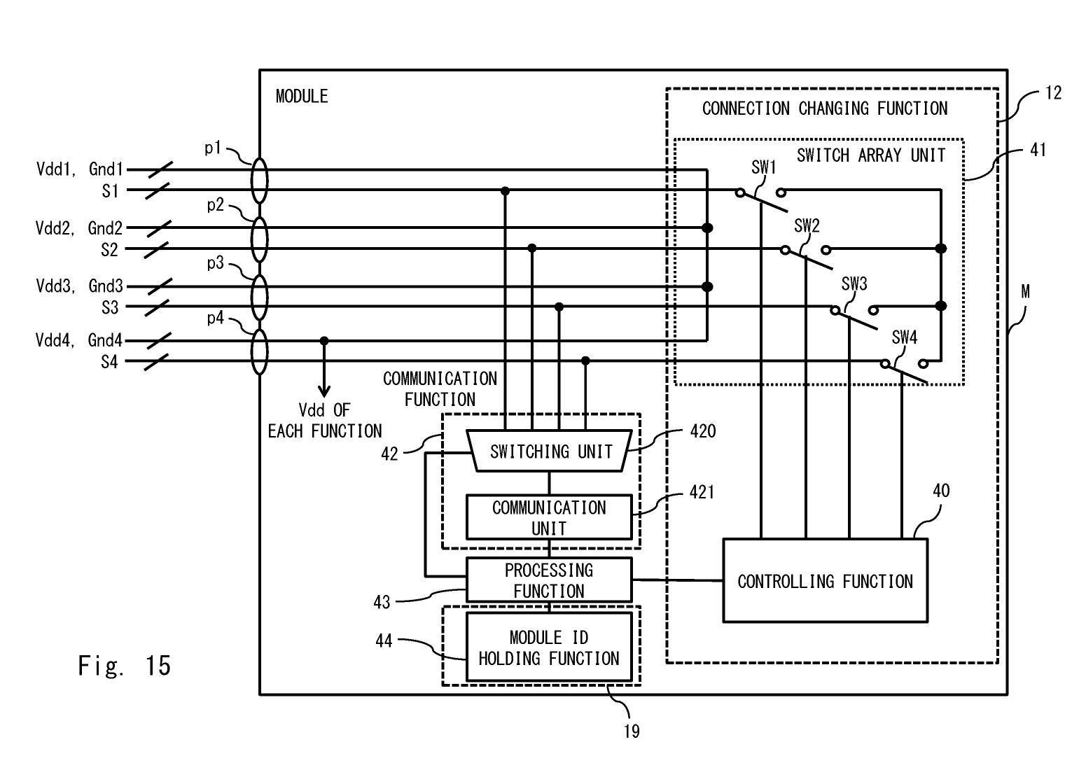

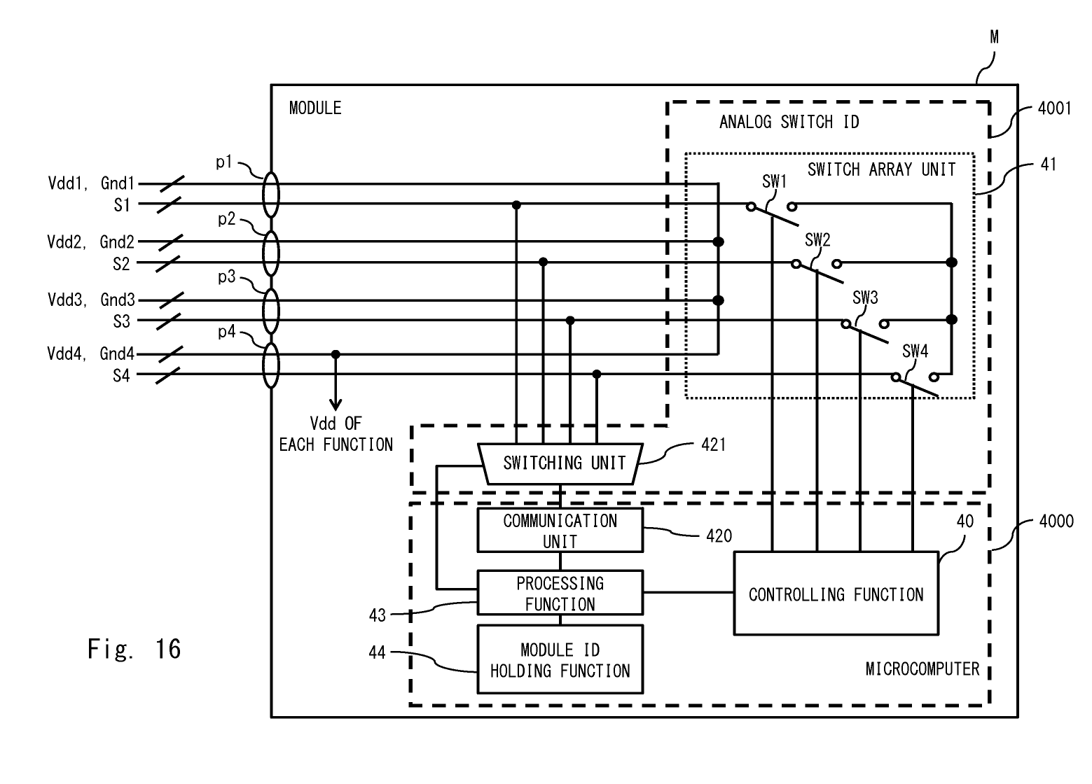

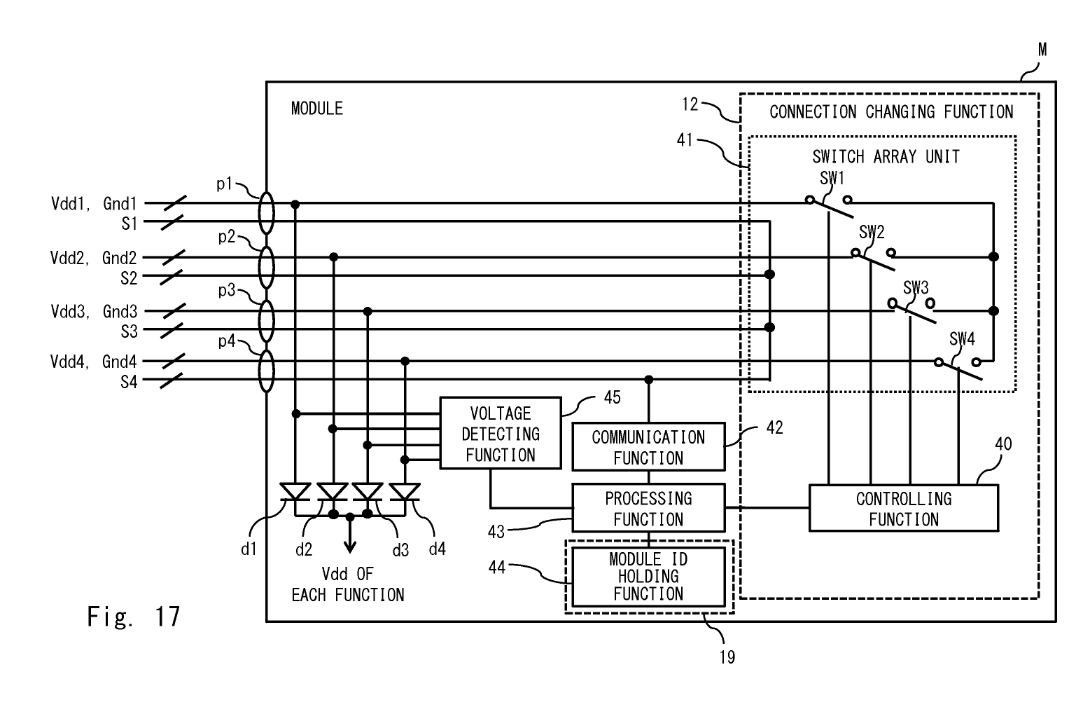

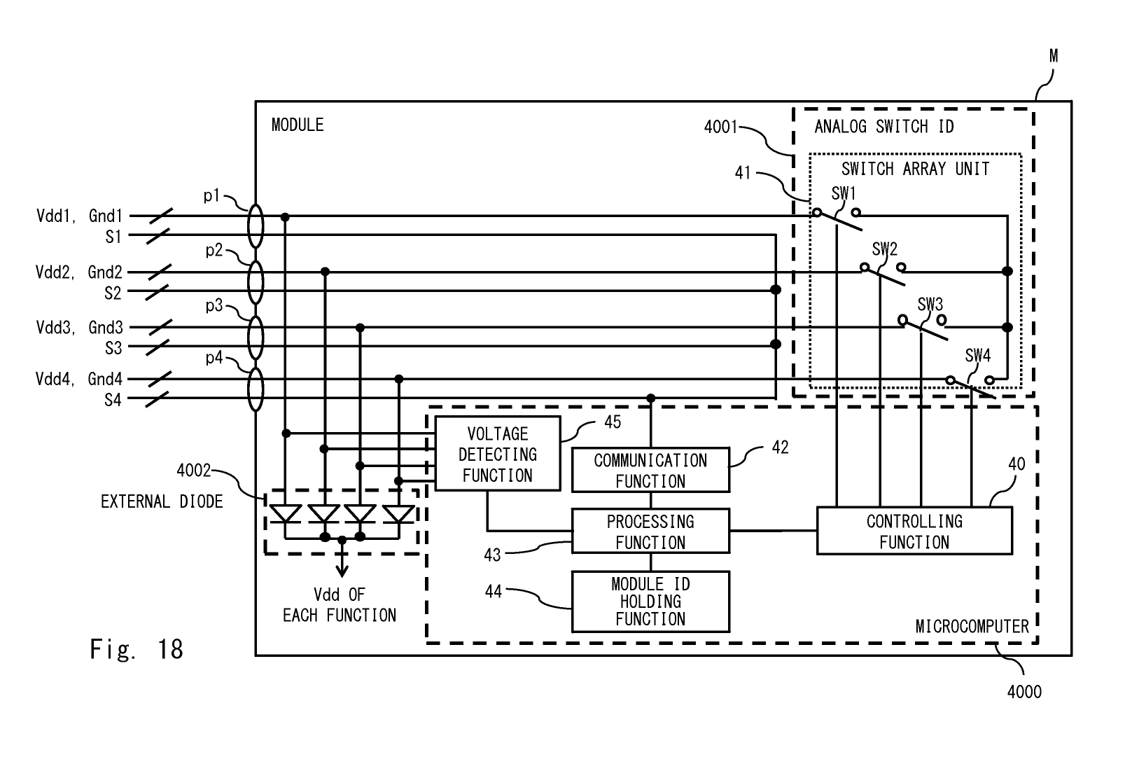

Next, more detailed configuration examples of the module M will be described with reference to FIGS. 15 to 18. Hereinafter, two configuration examples will be described. First, a first configuration example will be described with reference to FIGS. 15 and 16, and a second configuration example will be described with reference to FIGS. 17 and 18. In addition, FIGS. 15 to 18 illustrate more detailed configurations of the module M illustrated in FIG. 14.

As illustrated in FIG. 15, the first configuration example is an example where connection states of the signal lines S1 to S4 between the connection ports p1 to p4 are changed. According to the first configuration example, the switch array unit 41 includes the switches SW1 to SW4 whose number corresponds to the connection ports p1 to p4.

In the first embodiment, each of the power voltage lines Vdd1 to Vdd4 is short-circuited in the switch array unit 41 without the switches SW1 to SW4. Further, each of the ground lines Gnd1 to Gnd4 is directly short-circuited in the switch array unit 41 without the switches SW1 to SW4. Meanwhile, each of the signal lines S1 to S4 is short-circuited in the switch array unit 41 through the switches SW1 to SW4.

More specifically, each of the switches SW1 to SW4 is connected with each of the signal lines S1 to S4. One end of the switch SW1 is connected with the signal line S1 from the connection port p1, one end of the switch SW2 is connected with the signal line S2 from the connection port p2, one end of the switch SW3 is connected with the signal line S3 from the connection port p3, and one end of the switch SW4 is connected with the signal line S4 from the connection port p4. Each of other ends of the switches SW1 to SW4 is connected with each other.

According to such a configuration, by switching the two arbitrary switches SW to on, the two signal lines S connected with these two switches SW are connected. In other words, by switching the two arbitrary switches SW to on, the two connection ports p connected to these two switches SW are connected. Thus, when the host 2 side and another module M are connected to each of these two connection ports p, the host 2 can communicate with another module M through the module M which connects these connection ports. Further, the signal lines S1 to S4 are connected with the communication function 42. The power voltage lines Vdd1 to Vdd4 and the ground lines Gnd1 to Gnd4 are connected to each of the functions 12, 40 and 42 to 44 included in the module M. Thus, each of the functions 12, 40 and 42 to 44 operates based on power voltages and ground voltages supplied from the host 2 through the power voltage lines Vdd1 to Vdd4 and the ground lines Gnd1 to Gnd4.

In the first embodiment, the communication function 42 includes a switching unit 420 and a communication unit 421. The switching unit 420 is connected with the signal lines S1 to S4. The switching unit 420 selectively connects one of the signal lines S1 to S4 with the communication unit 421. In other words, the switching unit 420 selectively outputs one of signals received through the signal lines S1 to S4, to the communication unit 421. Further, the switching unit 420 selectively transmits the signal outputted from the communication unit 421, to one of the signal lines S1 to S4.

The switching unit 420 repeatedly switches a signal line to be connected with the communication unit 421 in order of the signal lines S1, S2, S3 and S4 per certain time interval under control of the processing function 43. This is because one of the signal lines S1 to S4 is connected with the host 2 side, and, therefore, even when one of the signal lines S1 to S4 is connected with the host 2 side, it is possible to detect a signal transmitted from the host 2. When receiving a signal from the host 2 through the communication unit 421 while the given signal line S and the communication unit 421 are connected, the processing function 43 interrupts control of switching the signal line S to be connected with the communication unit 421 in the switching unit 420, and maintains connection of this signal line S and the communication unit 421. Further, the processing function 43 requests the controlling function 40 to switch to on the switch SW connected with this signal line S.

Thus, only by changing a connection state of one switch SW by switching the switch at the host 2 side to on at all times, it is possible to connect the connection port p at the host 2 side and another connection port p.

The communication unit 421 converts the information outputted from the processing function 43 into a signal of a format which can be transmitted through the signal lines S1 to S4, and transmits the signal through the switching unit 420. The format of this converted signal complies with the adopted bus standards as described above. Further, the communication unit 421 receives the signal through the switching unit 420, converts the signal into the format which can be processed in the module M and outputs the signal to the processing function 43.

Next, a hardware configuration in the first configuration example of the module M according to the first embodiment will be described with reference to FIG. 16.

As illustrated in FIG. 16, the module M includes a microcontroller 4000 and an analog switch IC 4001. The microcontroller will be also referred to as a “microcomputer” below.

The microcomputer 4000 includes the controlling function 40, the processing function 43, the module ID holding function 44 and the communication unit 421. The analog switch IC 4001 functions as the switch array unit 41 and the switching unit 420.

Thus, in the module M according to the first embodiment, an analog switch IC configures the switch array unit 41 and the switching unit 420, and the low-cost microcomputer 4000 which only controls an analog switch IC can configure other components. Consequently, it is possible to realize the low-cost module M.

As illustrated in FIG. 17, the second configuration example is an example where connection states of the power voltage lines Vdd1 to Vdd4 and the ground lines Gnd1 to Gnd4 between the connection ports p1 to p4 are changed. In the second configuration example, the switch array unit 41 includes the switches SW1 to SW4 whose number corresponds to the connection ports p1 to p4.

In the second embodiment, each of the signal lines S1 to S4 is short-circuited in the switch array unit 41 without the switches SW1 to SW4. Meanwhile, each of the power voltage lines Vdd1 to Vdd4 is short-circuited in the switch array unit 41 through the switches SW1 to SW4. Further, each of the ground lines Gnd1 to Gnd4 is short-circuited in the switch array unit 41 through the switches SW1 to SW4.

More specifically, each of the switches SW1 to SW4 is connected with each of the power voltage lines Vdd1 to Vdd4. One end of the switch SW1 is connected with the power voltage line Vdd1 from the connection port p1, one end of the switch SW2 is connected with the power voltage line Vdd2 from the connection port p2, one end of the switch SW3 is connected with the power voltage line Vdd3 from the connection port p3, and one of the switch SW4 is connected with the power voltage line Vdd4 from the connection port p4. Each of the other ends of the switches SW1 to SW4 is connected with each other.

Further, each of the switches SW1 to SW4 is connected with each of the ground lines Gnd1 to Gnd4. One end of the switch SW1 is connected with the power voltage line Gnd1 from the connection port p1, one end of the switch SW2 is connected with the power voltage line Gnd2 from the connection port p2, one end of the switch SW3 is connected with the power voltage line Gnd3 from the connection port p3, and one end of the switch SW4 is connected with the power voltage line Gnd4 from the connection port p4. Each of the other ends of the switches SW1 to SW4 is connected with each other.

In addition, naturally, connection states of the power voltage lines Vdd1 to Vdd4 and the ground lines Gnd1 to Gnd4 are independently switched by the switches SW1 to SW4.

According to this configuration, by switching the two arbitrary switches SW to on, the two power voltage lines Vdd connected to these two switches SW are connected. Further, the two ground lines Gnd connected to these two switches SW are connected. In other words, when the two arbitrary switches SW are switched to on, the two connection ports p connected to these two switches SW are connected. Thus, when the two connection ports are connected with the host 2 side and another module M, respectively, a power voltage and a ground voltage from the host 2 are supplied to another module M through the module M which connects the connection ports p. Consequently, another module M can operate, and the host 2 can communicate with another module M through the module M which connects the connection ports p.

Further, the signal lines S1 to S4 are connected with the communication function 42. The power voltage lines Vdd1 to Vdd4 and the ground lines Gnd1 and Gnd4 are connected to the functions 12, 40 and 42 to 44 included in the module M. Thus, each of the functions 12, 40 and 42 to 45 operates based on a power voltage and a ground voltage supplied from the host 2 through the power voltage lines Vdd1 to Vdd4 and the ground lines Gnd1 to Gnd4.

In the second embodiment, the module M includes a voltage detecting function 45 and diodes d1 to d4. The voltage detecting function 45 detects a power supply voltage and a ground voltage supplied to the module M through the power voltage lines Vdd1 to Vdd4 and the ground lines Gnd1 to Gnd4. In this regard, the voltage detecting function 45 detects a pair which has first supplied a voltage (a power voltage and a ground voltage) to the voltage detecting function 45, from a pair of the power voltage line Vdd1 and the ground line Gnd1, a pair of the power voltage line Vdd2 and the ground line Gnd2, a pair of the power voltage line Vdd3 and the ground line Gnd3 and a pair of the power voltage line Vdd4 and the ground line Gnd4.

Thus, by detecting first from which pair a power voltage and a ground voltage have been supplied, it is possible to specify which connection port p is connected with the host 2 side. That is, when a pair which has first received a supply of the power voltage and the ground voltage is the pair of the power voltage line Vdd1 and the ground line Gnd1, the connection port p1 is connected with the host 2 side. When a pair which has first received a supply of the power voltage and the ground voltage is the pair of the power voltage line Vdd2 and the ground line Gnd2, the connection port p2 is connected with the host 2 side. When a pair which has first received a supply of the power voltage and the ground voltage is the pair of the power voltage line Vdd3 and the ground line Gnd3, the connection port p3 is connected with the host 2 side. When a pair which has first received a supply of the power voltage and the ground voltage is the pair of the power voltage line Vdd4 and the ground line Gnd4, the connection port p4 is connected with the host 2 side.

The voltage detecting function 45 notifies the processing function 43 of a pair of the power voltage line Vdd and the ground line Gnd supplied first to the voltage detecting function 45. In other words, the voltage detecting function 45 notifies the processing function 43 of the connection port p which has first supplied the voltage to the voltage detecting function 45.

The processing function 43 requests the controlling function 40 to switch to on the switch SW corresponding to a pair (connection port p) of the power voltage line Vdd and the ground line Gnd notified from the voltage detecting function 45.

According to this configuration, only by changing a connection state of one switch SW by switching the switch SW at the host 2 side to on at all times, it is possible to connect the connection port p at the host 2 side and another connection port p.

The diode d1 is connected with the power voltage line Vdd1 and the ground line Gnd1. The diode d2 is connected with the power voltage line Vdd2 and the ground line Gnd2. The diode d3 is connected with the power voltage line Vdd3 and the ground line Gnd3. The diode d4 is connected with the power voltage line Vdd4 and the ground line Gnd4. That is, the power voltages and the ground voltages supplied through the power voltage lines Vdd1 to Vdd4 and the ground lines Gnd1 to Gnd4 are supplied to each of the functions 12, 40 and 42 to 45 of each module M through the diodes d1 to d4.

Anodes of the diodes d1 to d4 are connected with the power voltage lines Vdd1 to Vdd4 and the ground lines Gnd1 to Gnd4, and cathodes of the diodes d1 to d4 are connected with each of the functions 12, 40 and 42 to 45 of the module M. Thus, the voltage is prevented from being supplied to another module M through paths for supplying voltages to each of the functions 12, 40 and 42 to 45.

Next, a hardware configuration in the second configuration example of the module M according to the first embodiment will be described with reference to FIG. 18.

As illustrated in FIG. 18, the module M includes the microcomputer 4000, the analog switch IC 4001 and an external diode 4002.

The microcomputer 4000 functions as the controlling function 40, the communication function 42, the processing function 43, the module ID holding function 44 and the voltage detecting function 45. The analog switch IC 4001 functions the switch array unit 41. The external diode 4002 functions as the diodes d1 to d4.

Thus, the module M according to the second embodiment includes the analog switch IC 4001 and the external diode 4002 as separate ICs, and the low-cost microcomputer 4000 which controls analog switch ICs can configure other components. Consequently, it is possible to realize the low-cost module M.

Further, in the first configuration example illustrated in FIGS. 15 and 16, the analog switches SW1 to SW4 are inserted between the signal lines S1 to S4, and therefore a signal waveform deteriorates. By contrast with this, in the second configuration example illustrated in FIGS. 17 and 18, the analog switches SW1 to SW4 are not inserted between the signal lines S1 to S4, and therefore there is an advantage that a signal waveform does not deteriorate.

(Detailed Operation in First Embodiment)

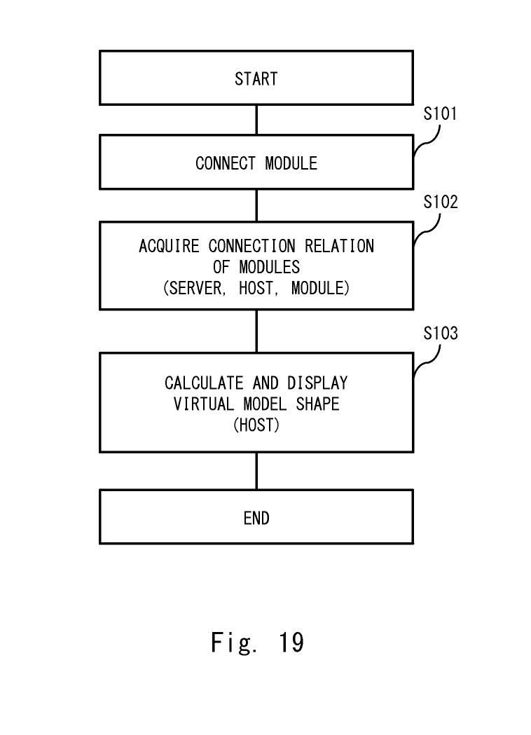

Next, an operation of the virtual model generating system 1 according to the first embodiment will be described with reference to FIG. 19.

The user creates a physical model by connecting a plurality of modules M to each other (S101). The connection detecting function 10 of the host 2 acquires a connection relation of a plurality of modules which compose a physical model in association with the server 3 and a plurality of modules M (S102). More specifically, as described above, the connection detecting function 10 of the host 2 repeatedly acquires a module ID list, acquires the number of connection ports of the newly detected module M and change a connection state of the connection ports p of the module M to acquire the connection relation of a plurality of modules M.

The virtual model generating function 11 of the host 2 calculates a shape of a virtual model based on the connection relation of a plurality of modules acquired by the connection detecting function 10, and displays the calculated shape of the virtual model (S103).

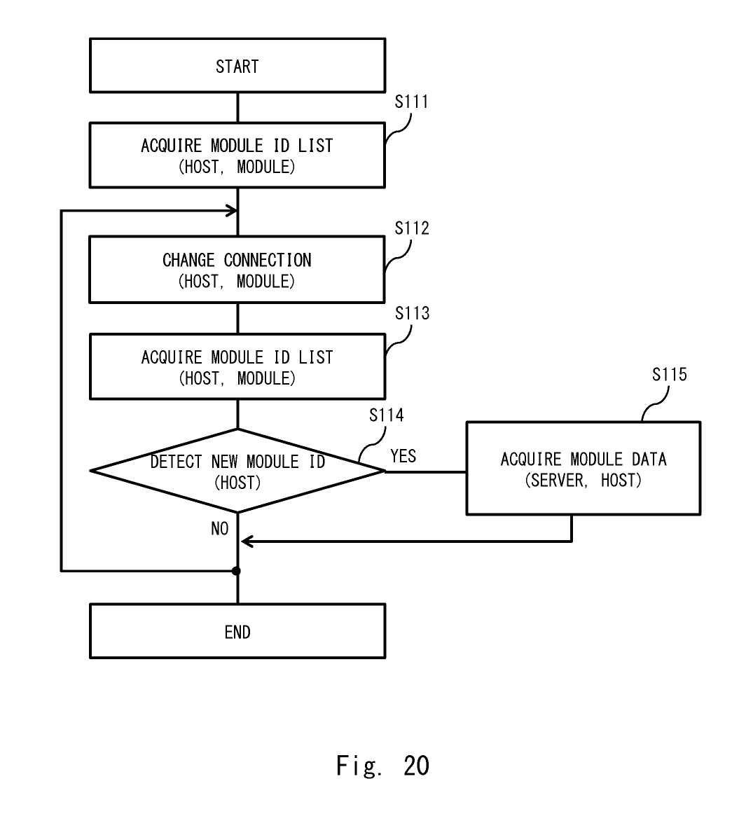

Next, an operation of connection relation acquisition processing (S102) of the virtual model generating system 1 according to the first embodiment of the present invention will be described with reference to FIG. 20.

The module ID acquiring means 21 of the host 2 acquires the module ID list (S111). First, all connection ports of the module M directly connected to the host 2 are disconnected, and therefore the module ID acquiring means 21 acquires only a module ID of the module M directly connected to the host 2.

Hereinafter, the connection detecting function 10 of the host 2 repeats processing in steps S112 to S114 described below with respect to all combinations of the connection ports at the host 2 side and the other connection ports p in all modules M. The connection relation managing unit 202 of the host 2 switches the switches SW of each module M to on and connects the connection ports p (S112). The module ID acquiring means 21 of the host 2 acquires the module ID list (S113). Thus, the module ID acquiring means 21 of the host 2 acquires module IDs from all modules M connected with the host 2.

The ID comparing unit 200 of the host 2 determines whether or not there is a new module ID in the module ID list acquired this time by the module ID acquiring means 21 by comparing the module ID list acquired at this time by the module ID acquiring means 21 and the module ID list previously acquired by the module ID acquiring means 21 (S114).

When the ID comparing unit 200 determines that there is the new module ID (S114: Yes), the connection relation managing unit 202 of the host 2 acquires module data of the module M specified based on this module ID, from the server 3 (S115).

As described with reference to FIG. 5, an acquired module ID is repeatedly checked while connecting the connection ports p of each module M in order. Thus, when another module M is connected via the given module M, a new module ID can be detected by acquiring a module ID immediately after the connection ports p are connected. Further, the connection ports p are connected in order in the new module M, and therefore it is necessary to recognize the number of connection ports of the new module M, too. Consequently, by acquiring module data from the server 3, it is possible to acquire the number of connection ports of the newly detected module M.

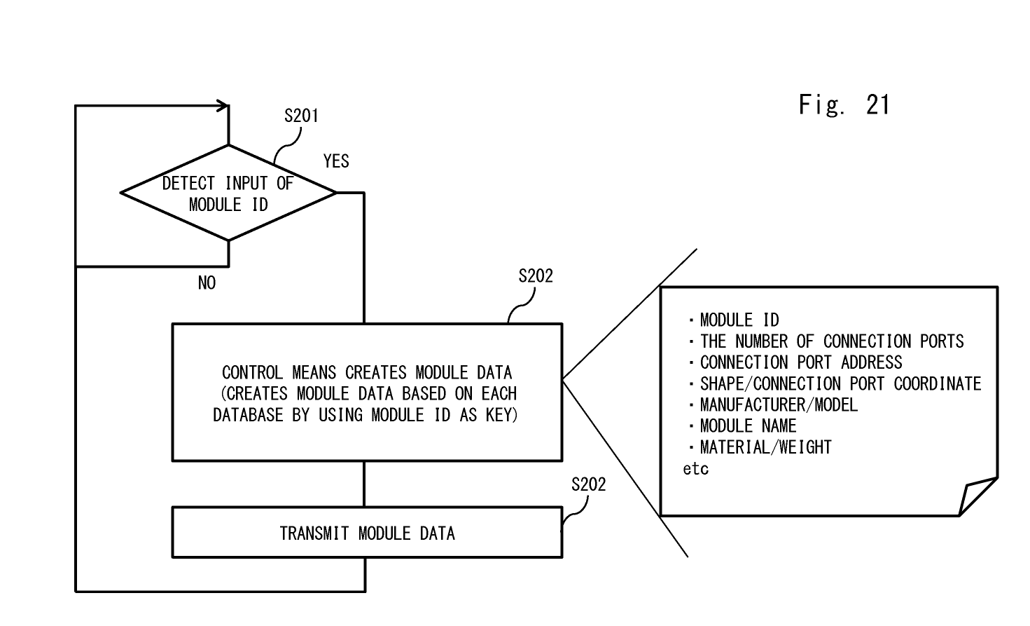

Next, an operation of the server 3 according to the first embodiment will be described with reference to FIG. 21.

The control means 30 of the server 3 continuously determines whether or not a module ID has been inputted (S201). More specifically, the control means 30 continuously determines whether or not the host 2 has made an inquiry by using the module ID as a key. In other words, the control means 30 continuously determines whether or not a data transmission request has been received from the host 2 through the input means 31.

In case where the module ID has been inputted (S201: Yes), the control means 30 of the server 3 generates module data of the module M specified based on each of the databases 302 to 307 and based on this module ID by using the inputted module ID as the key (S202). The control means 30 of the server 3 transmits the generated module data to the host 2 through the output means 32.

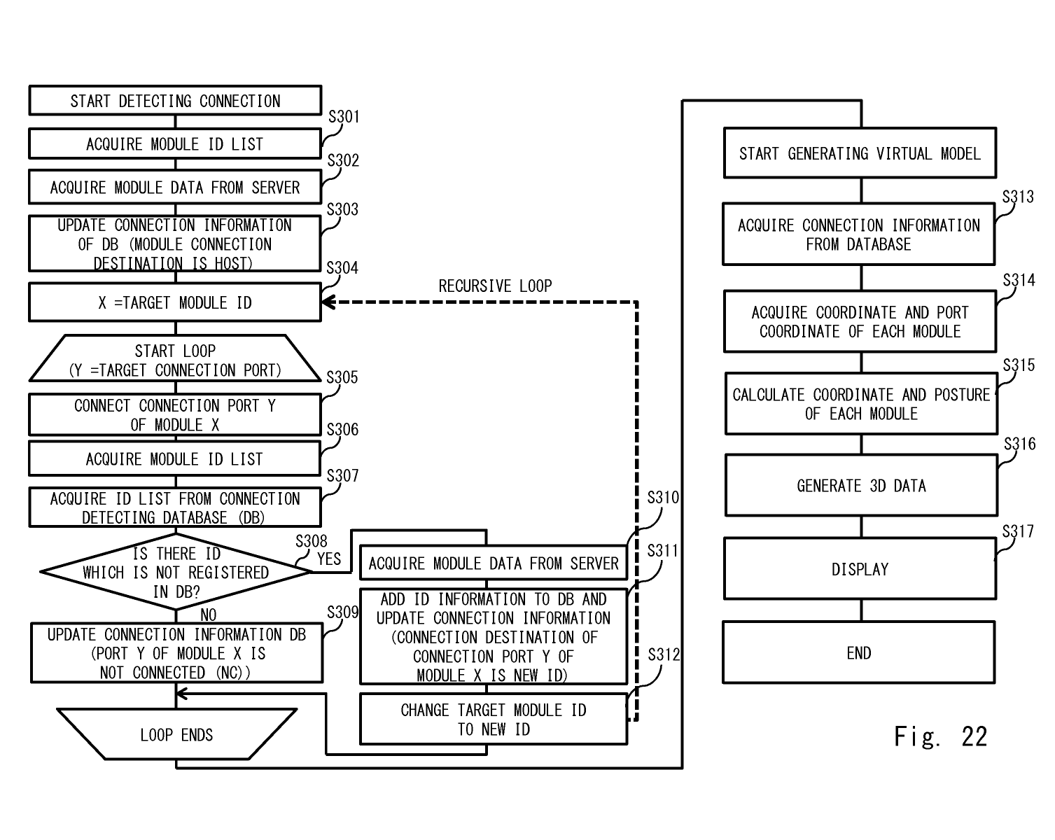

Next, an operation of the host 2 according to the first embodiment will be described with reference to FIG. 22. In FIG. 22, steps S301 to S312 are processing of detecting a connection relation of a plurality of modules M, and steps S313 to S318 are processing of generating of a virtual model.

The connection relation managing unit 202 of the host 2 acquires a module ID list of the modules M connected with the host 2 (S301). More specifically, the connection relation managing unit 202 of the host 2 requests the module ID acquiring means 21 to acquire the module ID list. The module ID acquiring means 21 returns an ID return command to all modules M in response to a request from the connection relation managing unit 202. The ID return command is received by the module M connected with the host 2. The processing function 43 of the module M transmits to ID information indicating a module ID of the module M to the host 2 in response to the ID return command from the host 2. First, all connection ports are disconnected in the module M directly connected to the host 2, and therefore ID information is transmitted to the host 2 only from the module M directly connected to the host 2. The module ID acquiring means 21 receives the ID information transmitted from the module M. The connection relation managing unit 202 acquires module IDs indicated by the ID information received by the module ID acquiring means 21 as a module ID list. Hence, this module ID list indicates only module IDs of the modules M directly connected to the host 2.

The connection relation managing unit 202 of the host 2 acquires module data of the module M specified based on the acquired module ID, from the server 3 (S302). More specifically, the connection relation managing unit 202 transmits data request information indicating this module ID, to the server 3. The control means 30 of the server 3 generates module data of the module M specified based on the module ID indicated by this data request information according to data request information from the host 2, and transmits the module data to the host 2. The information inquiring means 26 of the host 2 receives the module data of the module M specified based on a new module ID. The connection port number acquiring unit 201 of the host 2 acquires the number of connection ports from the module data received by the information inquiring means 26.

The connection relation managing unit 202 of the host 2 updates the connection detecting database 209 (S303). More specifically, the connection relation managing unit 202 updates the connection detecting database 209 such that the connection detecting database 209 indicates the module M specified based on the acquired module ID. The connection relation managing unit 202 updates the connection detecting database 209 such that the connection detecting database 209 indicates the number of connection ports acquired by the connection port number acquiring units 201 as the number of connection ports of the module M specified based on the acquired module ID.

Further, the processing function 43 of the module M transmits port information indicating the connection port p which has received an ID return command among the connection ports p included in this module M, to the host 2 in response to an ID return command from the host 2. The connection relation managing unit 202 of the host 2 receives the port information transmitted by the module M through the communication control means 23. The connection relation managing unit 202 updates the connection detecting database 209 such that the host 2 is connected with the connection port p indicated by the received port information among the connection ports p of the module M specified based on the acquired module ID.

Hereinafter, processing in steps S304 to S312 is configured by loop processing of connecting the connection port p at the host 2 side and another connection port p one by one in this module M by focusing the given module M (module ID=X). In addition, as described above, only the module M directly connected to the host 2 is recognized, and therefore the connection relation managing unit 202 of the host 2 sets the module M directly connected to the host 2 as the first processing target module M. The processing target connection port p (connection port=Y) is changed every time the connection port p other than a connection port at the host 2 side executes processing (steps S305 to S312) per loop processing.

The connection relation managing unit 202 of the host 2 connects the connection port p at the host 2 side in the processing target module M, and the processing target connection port p (S305). The connection relation managing unit 202 of the host 2 requests the command generating means 22 to connect the connection port p at the host 2 side in the processing target module M, and the processing target connection port p. The command generating means 22 generates a connection change command for requesting connection of the connection port p at the host 2 side in the processing target module M and the processing target connection port p in response to the request from the connection relation managing unit 202, and transmits the connection change command to the processing target module M. The processing function 43 of the module M connects the connection port p at the host 2 side and the processing target connection port p according to the connection change command from the host 2. That is, the processing function 43 switches to on the switch SW corresponding to the processing target connection port p.

The connection relation managing unit 202 of the host 2 acquires a module ID list of the modules M connected with the host 2 (S306). This specific processing is as described in step S301. In this regard, the connection port p at the host 2 side and the processing target connection port p are connected, and therefore, when the new module M is connected to the processing target connection port p, a module ID of this module M is also acquired.

The ID comparing unit 200 of the host 2 acquires the module ID list from the connection detecting database 209 (S307). That is, the ID comparing unit 200 acquires module IDs stored in the connection detecting database 209. This module ID list has the same contents as those of a module ID list previously acquired in step S307.

The ID comparing unit 200 compares the module ID list acquired from the connection detecting database 209 in step S307, and the module ID list from the module M connected with the host 2 in step S306. Thus, the ID comparing unit 200 determines whether or not there is a module ID which exists in the module ID list acquired from the module M connected with the host 2 yet does not exist in the module ID list acquired from the connection detecting database 209 (S308). In other words, the ID comparing unit 200 determines whether or not there is a new module ID in the module ID list acquired this time from the module M connected with the host 2.

When there is not a module ID which does not exist in the module ID list acquired from the connection detecting database 209 (S308: No), the connection relation managing unit 202 of the host 2 updates the connection detecting database 209 (S309). More specifically, the connection relation managing unit 202 updates the connection detecting database 209 such that the module M is not connected to the processing target connection port p in the processing target module M (S309).

When there is the module ID which does not exist in the module ID list acquired from the connection detecting database 209 (S308: Yes), the connection relation managing unit 202 of the host 2 acquires module data of the module M specified based on the new module ID, from the server 3 (S310). This specific processing is described in step S302.

The connection relation managing unit 202 of the host 2 updates the connection detecting database 209 (S311). More specifically, similar to step S303, the connection relation managing unit 202 updates the connection detecting database 209 such that the connection detecting database 209 indicates the module M specified based on the new module ID. The connection relation managing unit 202 updates the connection detecting database 209 such that the connection detecting database 209 indicates the number of connection ports acquired by the connection port number acquiring unit 201 as the number of connection ports of the module M specified based on the new module ID.

Further, similar to step S303, the processing function 43 of the new module M transmits port information indicating the connection port p which has received an ID return command among the connection ports p of the new module M, to the host 2 in response to the ID return command from the host 2 in step S306. The connection relation managing unit 202 of the host 2 receives the port information transmitted from the new module M, through the communication control means 23. The connection relation managing unit 202 updates the connection detecting database 209 such that the processing target module M is connected to the connection port p indicated by the received port information among the connection ports p of the module M specified based on the new module ID.

The connection relation managing unit 202 of the host 2 sets the module M specified based on the new module ID, as the processing target module M (S312 and S304), and recursively executes loop processing (S305 to S312). By so doing, as described with reference to FIG. 5, it is possible to detect a connection relation of a plurality of modules M which target all connection ports p of all modules M as processing targets in order.

When the loop processing is finished and detecting the connection relation of a plurality of modules M is finished, the host 2 starts generating a virtual model.

The shape/connection port coordinate acquiring unit 210 of the host 2 acquires information indicating the connection relation of a plurality of modules M from the connection detecting database 209 (S313). Further, the shape/connection port coordinate acquiring unit 210 acquires information (e.g. STC format data) indicating a shape of each module M and information indicating a coordinate of each connection port p of each module M from the module database 219 (S314).

The module coordinate calculating unit 211 of the host 2 calculates the coordinate of each module M based on information acquired by the shape/connection port coordinate acquiring unit 210. Further, the module posture calculating unit 212 of the host 2 calculates the posture of each module M based on information acquired by the shape/connection port coordinate acquiring unit 210 (S315).

For example, all modules M are cubes having the same size, and there is the connection port p in the center of each plane. Further, the coordinate of the module M is indicated as the center (the center of gravity) of the module M. In this case, when the connection port p1 of the module M2 is connected on the connection port p1 of the module M, a position of the coordinate of the module M2 is calculated as a position higher than the position of the module M1 by a height of the module M. Further, the posture of the module M2 is calculated as such a posture that the connection port p1 of the module M2 is rotated to come into contact with the connection port p1 of the module M1.

The 3D data generating unit 213 of the host 2 generates a three-dimensional virtual model based on calculation results of the module coordinate calculating unit 211 and the module posture calculating unit 212 (S316). In this regard, the virtual model generating means 24 can acquire a shape, a coordinate and a posture of each module M, and therefore a range which each module M occupies is specified based on the shape, the coordinate and the posture in the calculated three-dimensional space. Hence, the 3D data generating unit 213 generates a virtual model by integrating pieces of information of each module M. Further, the 3D data generating unit 213 displays the generated virtual model on the display means 25 (S317). Furthermore, the 3D data generating unit 213 may perform a simulation by using the generated virtual model. In this case, the 3D data generating unit 213 can perform a simulation by acquiring the material and the weight of each module M which composes the virtual model, from module data stored in the module database 219 and by taking into account a material and a weight of each module M.

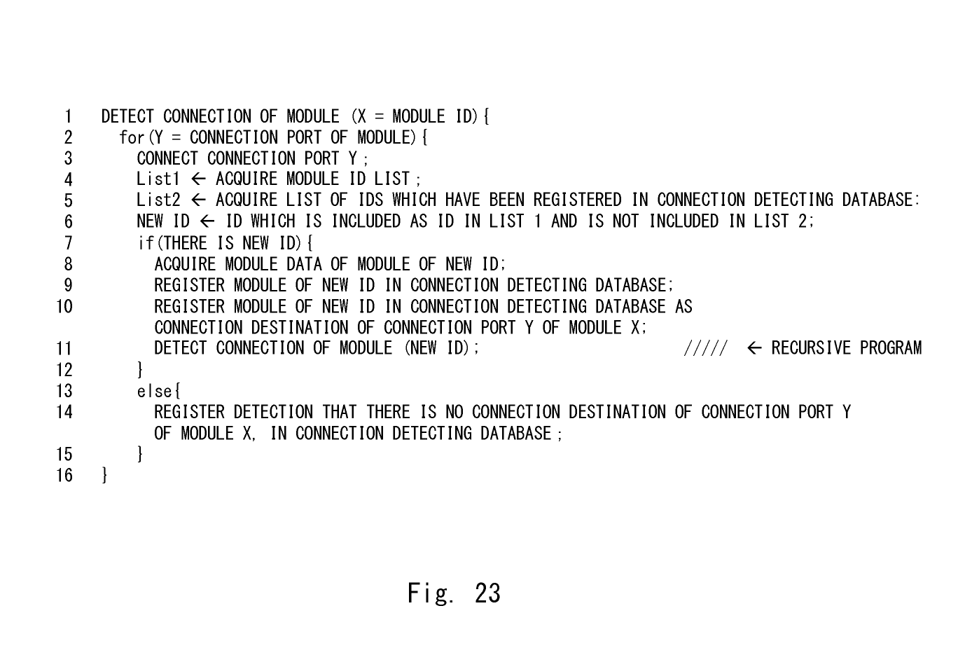

Next, recursive loop processing in step S304 to S312 in FIG. 22 will be described in a different format with reference to FIG. 23. FIG. 23 is a view conceptually illustrating a program example of the recursive loop processing to help understanding of the recursive loop processing. In addition, numbers indicated on a left side of description of a program indicate row numbers indicated for convenience of description, and are not described in an actual program. That is, the program illustrated in FIG. 23 is included in the host program 299.

The first row corresponds to steps S304 and S312. The first row indicates a function “module connection detection” of the recursive loop processing indicated in steps S304 to S312. Further, the first row indicates that a processing target module ID is specified by using this function as an argument. When, for example, an invocation is made for the first time, a module ID of the module M directly connected with the host 2 is specified. Hence, processing (processing in the second to fifteenth rows) in the function is executed with respect to the module M of the module ID specified as a processing target according to an argument.

The second row indicates start of the loop processing in steps S305 to S312. Further, the second row indicates that every time this loop processing is performed once, the processing target connection port p is changed. That is, the loop processing (processing in the third to fifteenth rows) is executed with respect to each of all connection ports p of the processing target module M.

Third to fifth rows correspond to steps S305 to S307. List1 indicates a variable in which a module ID list acquired from each module M is stored. List2 indicates a variable in which the module ID list acquired from the connection detecting database 209 is stored. List1 and List2 are prepared as array variables, and can store a plurality of module IDs.

Sixth, seventh and thirteenth rows correspond to step S308. A new ID is a variable in which a module ID which is included in List1, and is not included in List2 is stored. That is, the newly detected module ID is stored. When, for example, a new module ID is not detected in the sixth row, it possible to determine that a new module ID has been detected in case where a value of a new ID is changed in the seventh row by changing the value of the new ID, and, when the value of the new ID is not changed, it is possible to determine that a new module ID is not detected in case where the value of the new ID is not changed.

Eighth to twelfth rows correspond to steps S310 to S312. After module data is acquired and the connection detecting database 209 is updated, the function “module connection detection” is recursively invoked by using a newly detected module ID as an argument. Thus, as described with reference to FIG. 5, the connection ports p are connected in order in each module M, so that it is possible to recognize a connection relation of a plurality of modules M. In addition, fourteenth and fifteenth rows correspond to step S309.

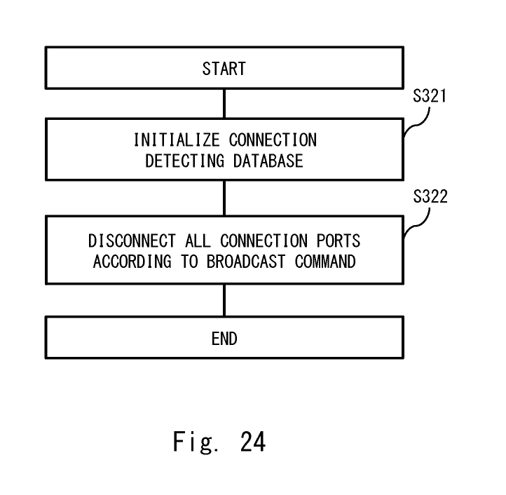

Next, an operation of pre-processing of the host 2 according to the first embodiment will be described with reference to FIG. 24. The processing illustrated in FIG. 24 is executed before processing of detecting a connection relation of a plurality of modules M illustrated in FIG. 22. That all connection ports of each module M are first disconnected has been described, and the disconnection is realized by processing illustrated in FIG. 24.

The connection relation managing unit 202 of the host 2 initializes the connection detecting database 209 (S321). That is, the connection relation managing unit 202 causes the connection detecting database 209 to indicate that there is no connection relation of the modules M.

The connection relation managing unit 202 of the host 2 disconnects all connection ports p of all modules M according to a broadcast command (S322). More specifically, the connection relation managing unit 202 transmits a connection change command for requesting disconnection of all connection ports p, to all modules M by way of broadcasting. Thus, the processing functions 43 of all modules M disconnect all connection ports p. In other words, the processing functions 43 of all modules M switch all switches SW to off.

That is, an example where all connection ports p of all modules M are connected in advance will be described. However, all connection ports p in all modules M may be disconnected in advance upon assembly of a physical model. In this case, the above pre-processing is unnecessary.

In this regard, processing which takes into account that there are the modules M in which all connection ports p are connected in advance and the module M in which all connection ports p are disconnected in advance in a plurality of modules M which compose a physical model may be performed. That is, when the ID comparing unit 200 detects a plurality of new modules IDs, the connection relation managing unit 202 of the host 2 transmits a connection change command for requesting disconnection of all connection ports p, to the newly detected modules M, and acquires a module ID list again. Thus, it is possible to detect only a module ID of the module M closest to the host 2 side among a plurality of new modules IDs by detecting a new module ID again. Hence, it is possible to accurately recognize this module M as the module M connected to the module M whose connection state of the connection ports p has been lastly changed.

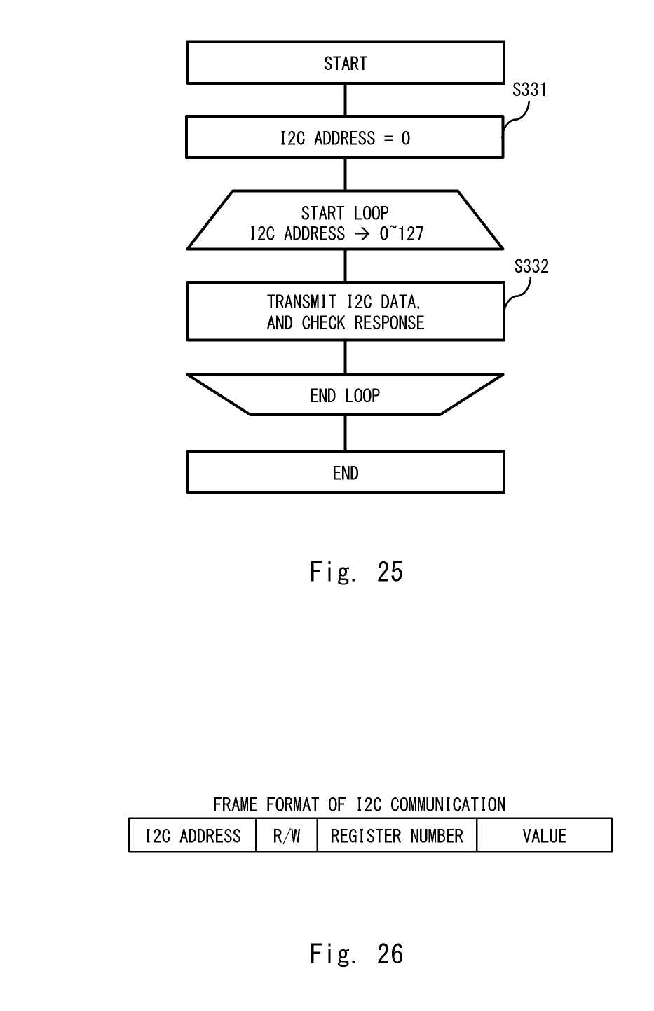

Next, module ID list acquisition processing (S301 and S306) of the host 2 according to the first embodiment will be described with reference to FIG. 25. Hereinafter, an example where I2C is adopted as communication standards for a bus configured by connecting the host 2 and the module M will be described. When I2C is adopted, if the host 2 transmits an ID return command to each module M by way of broadcasting, ID information from each module M which is a reply to the ID return command competes, and therefore there is a problem that ID information cannot be normally received by the host 2. According to processing illustrated in FIG. 25, this problem is solved by transmitting an ID return command by way of unicast in order to each module M.

The module ID acquiring means 21 of the host 2 initializes an I2C address specified by the ID return command (S331). In subsequent step S332, loop processing is executed by incrementing an I2C address from 0 which is a minimum value to 127 which is a maximum value. The module ID acquiring means 21 transmits I2C data which is the ID return command, to the module M, and checks whether or not there is a response from the module M (S332). The module ID acquiring means 21 receives ID information when ID information which is a response from the module M is transmitted. Thus, the module ID list including all pieces of received ID information is acquired.

Thus, according to I2C, I2C data of a frame format for specifying an I2C address is transmitted as illustrated in FIG. 26. I2C data includes a field for specifying an I2C address of the module M, a field for specifying read or write, a field for specifying a register number (connection port address) inside the module M and a field for specifying a value. For example, I2C data for specifying read and specifying a register number of a storage device in which module IDs are stored is transmitted as an ID return command. In addition, for example, I2C data for specifying write, specifying a register number (connection port address) of the control target connection port p, and specifying as a value whether or not to connect or disconnect the connection ports p are transmitted as connection change commands.

Meanwhile, an I2C address is fixedly allocated in advance to each module M. When receiving an ID return command whose I2C address allocated by the host 2 has been specified, the processing function 43 of the module M transmits ID information in response to this ID return command. In this regard, the host 2 does not know which modules M construct a physical model, and therefore does not know the I2C address of the module M, either. Hence, according to the above processing, it is possible to acquire a module ID by successively transmitting an ID return command for specifying each of 0 to 127 which is an address range which the I2C address can take.

In addition, an example where an ID return command is transmitted while an I2C address is incremented from 0 which is a minimum value to 127 which is a maximum value has been described. However, the present invention is not limited to this as long as an ID return command is transmitted to all I2C addresses. For example, an ID return command may be transmitted while an I2C address is decremented from 127 which is the maximum value to 0 which is the minimum value.

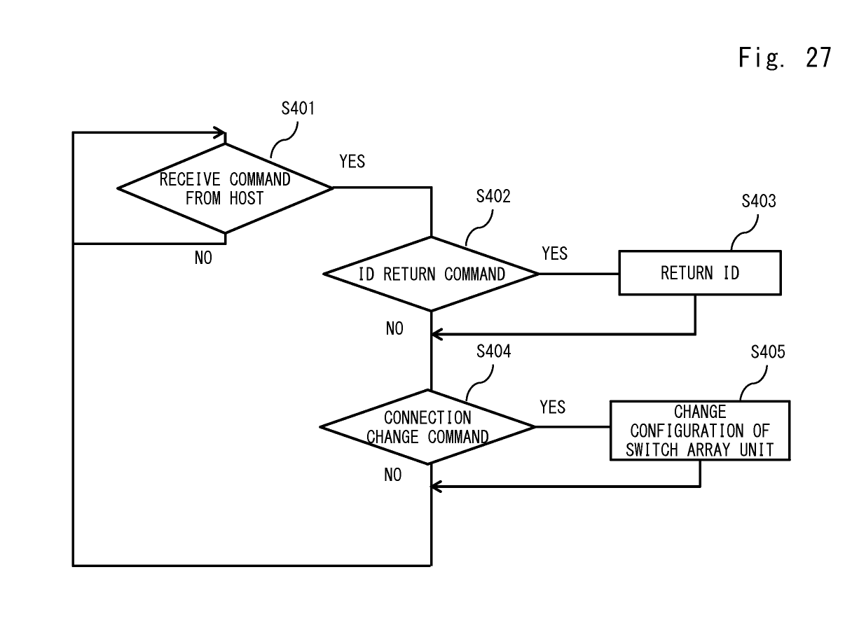

Next, an operation of the module M according to the first embodiment will be described with reference to FIG. 27.

The processing function 43 of the module M continuously determines whether or not a command is received from the host 2 (S401).

When receiving the command from the host 2 (S401: Yes), the processing function 43 determines whether or not the received command is an ID return command (S402). When the received command is the ID return command (S402: Yes), the processing function 43 returns ID information indicating a module ID, to the host 2 (S403). That is, the processing function 43 returns ID information stored in the module ID holding function 44, to the host 2.

Further, when the command is received from the host 2 (S401: Yes), the processing function 43 determines whether or not the received command is a connection change command (S404). When the received command is the connection change command (S404: Yes), the processing function 43 changes the configuration of the switch array unit 41 (S405). That is, the processing function 43 changes the connection state of the connection port p specified according to the connection change command.

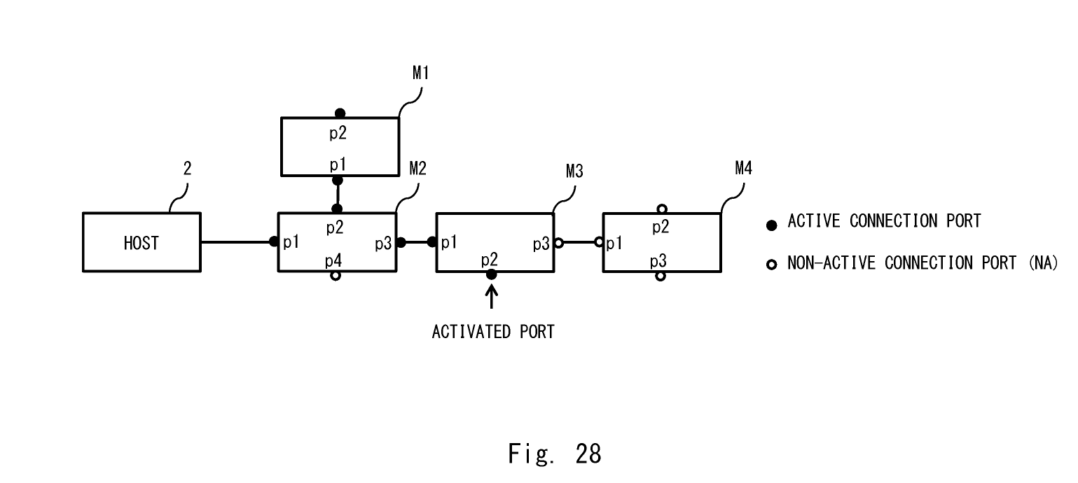

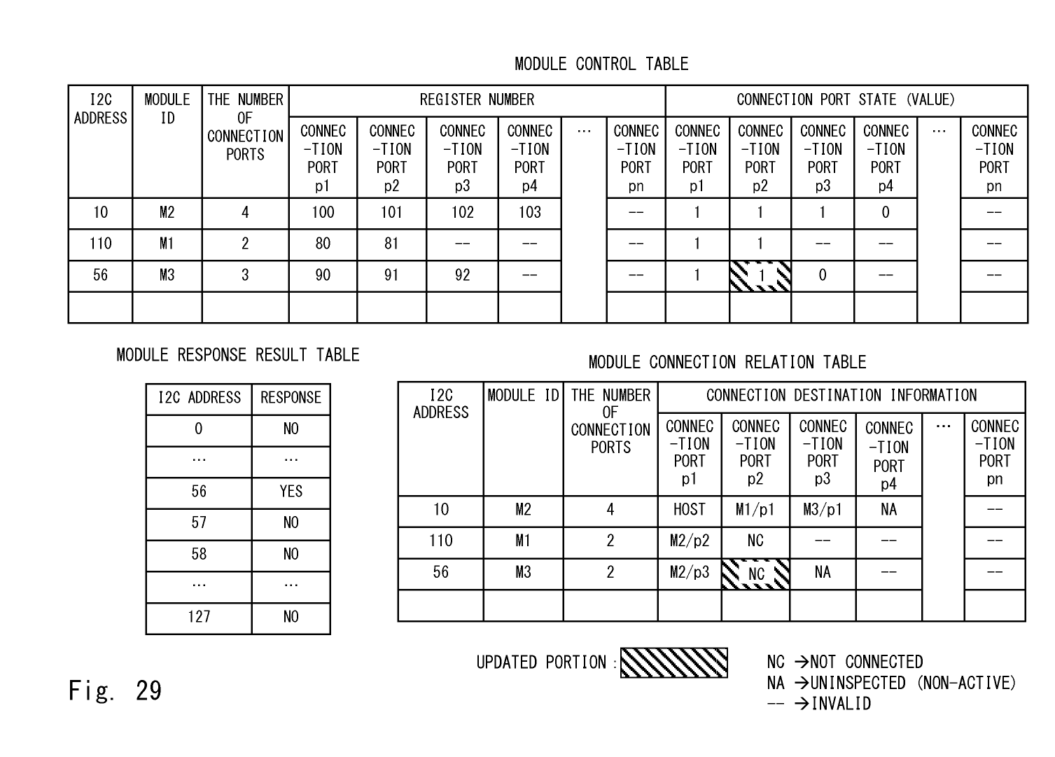

Next, a specific example of connection relation detection processing will be described to help understanding of the connection relation detection processing with reference to FIGS. 28 to 31. FIG. 28 is a view illustrating a connection example of the modules M1 to M4 according to the first embodiment. FIG. 28 illustrates a state where the connection relation detection processing progresses to some degree. The state illustrated in this FIG. 28 indicates a first state. FIG. 29 is a view illustrating information stored in the connection detecting database 209 in the first state in FIG. 28.

Hereinafter, an example where the modules M1 to M4 are connected to each other to construct a physical model as illustrated in FIG. 28 will be described. The module M1 includes two connection ports of the connection ports p1 and p2. The module M2 includes four connection ports of the connection ports p1 and p4. The module M3 includes three connection ports of the connection ports p1 to p3. The module M4 includes three connection ports of the connection ports p1 to p3.

The host 2 is connected with the connection port p1 of the module M2. The connection port p2 of the module M2 is connected with the connection port p1 of the module M1. The connection port p3 of the module M2 is connected with the connection port p1 of the module M3. The connection port p4 of the module M2 is not connected with another module M.

The connection port p2 of the module M1 is not connected with another module M. The connection port p2 of the module M3 is not connected with another module M. The connection port p3 of the module M3 is connected with the connection port p1 of the module M4. The connection ports p2 and p3 of the module M4 are not connected with another module M.

The module M1 is connected with the connection port p1 at the host 2 side and the connection port p2. The module M2 is connected with the connection port p1 at the host 2 side and each of the connection ports p2 and p3 yet is not connected with the connection port p1 at the host 2 side and the connection port p4. The module M3 is connected with the connection port p1 at the host 2 side and the connection port p2 yet is not connected with the connection port p1 at the host 2 side and the connection port p3. The module M4 is connected with the connection port p1 at the host 2 side and the connection ports p2 and p3.

In this regard, the host 2 connects the connection port p1 at the host 2 side and the connection port p2.

As illustrated in FIG. 29, in the connection detecting database 209, a module control table, a module response result table and a module connection relation table are stored. These tables are updated by the connection relation managing unit 202 of the host 2 as the connection relation detection processing progresses. In addition, these are the tables yet are not limited to information in table formats as long as the tables indicate the same contents, and may be information in different formats.

The module control table is information indicating an I2C address, a module ID, the number connection ports, a register number of each connection port p (connection port address) and a state of each connection port p of each module M detected by the host 2.

The module control table indicates that the module M2 takes “10” as the I2C address, “M2” as the module ID, “4” as the number of connection ports, “100” to “103” as the register numbers of the connection ports p1 to p4, “1” as the states of the connection ports p1 to p3 (the switches SW corresponding to the connection ports p are switched to on) and “0” as the state of the connection port p4 (the switch SW corresponding to the connection port p is switched to off).

The module control table indicates that the module M1 takes “110” as the I2C address, “M1” as the module ID, “2” as the number of connection ports, “80” and “81” as the register numbers of the connection ports p1 and p2, and “1” as the states of the connection ports p1 and p2 (the switches SW corresponding to the connection ports p are switched to on).

The module control table indicates that the module M3 takes “56” as the I2C address, “M3” as the module ID, “3” as the number of connection ports, “90” to “92” as the register numbers of the connection ports p1 to p3, “1” as the states of the connection ports p1 and p2 (the switches SW corresponding to the connection ports p are switched to on), and “0” as the state of the connection port p3 (the switch SW corresponding to the connection ports p is switched to on).

The module response result table is information indicating whether or not there are an I2C address and a response to an ID return command of this I2C address. The module response result table indicates that there have been responses to ID return commands of I2C address “10”, “56” and “110”, and there have not been responses to ID return commands of other I2C addresses.

The module connection relation table is information indicating an I2C address, a module ID, the number of connection ports and whether or not each connection port p is connected with the host 2 or another module M. Further, the module connection relation table indicates which connection port p of another module M is connected with the connection port p, too, when the connection port p is connected with another module M. The module connection relation table indicates the same contents of I2C addresses, module IDs and the numbers of connection ports as those of the module control table, and therefore will not be described.

The module connection relation table indicates that, in case of the module M2, the connection port p1 is connected with the host 2, the connection port p2 is connected with the connection port p1 of the module M1, the connection port p3 is connected with the connection port p1 of the module M3 and the connection port p4 is not yet inspected.

The module connection relation table indicates that, in case of the module M1, the connection port p1 is connected with the connection port p2 of the module M2, and the connection port p2 is connected with no connection destination.

The module connection relation table indicates that, in case of the module M3, the connection port p1 is connected with the connection port p3 of the module M2, the connection port p2 is connected with no connection destination and the connection port p3 is not yet inspected.

As I2C addresses and module IDs in the module control table and the module connection relation table, I2C addresses specified according to ID return commands by the connection relation managing unit 202 in step S332 and module IDs acquired in response to these ID return commands are set. As the numbers of connection ports in the module control table and the module connection relation table, the connection relation managing unit 202 sets the numbers of connection ports acquired by the connection port number acquiring unit 201 by using module IDs as keys. As a register number of each connection port p (connection port address), the connection relation managing unit 202 sets a connection port address of module data acquired by the information inquiring means 26 by using a module ID as a key.

As a state of the connection port p in the module control table, the connection relation managing unit 202 sets the state of this connection port p to “1” when requesting connection of the connection ports p. The connection relation managing unit 202 sets connection destination information in the module connection relation table such that the connection port p for which connection has been requested and the connection port p of the new module M which has been notified from the module M of the newly detected module ID according to an ID return notification are mutual connection destinations.

I2C addresses in the module response table are set in advance. As whether or not there is a response in the module response result table, the connection relation managing unit 202 sets whether or not there is a response to an I2C address specified by an ID return command in step S332.

In the first state, the connection relation managing unit 202 makes a connection request for the connection port p2 to the module M3, and updates the state of the connection port p2 of the module M3 in the module control table, to “1”. The connection port p2 of the module M3 is connected with no connection destination, and therefore a new module ID is not detected by acquiring a last module ID list even in a state where the connection port p2 of the module M3 is connected. As a result, the connection relation managing unit 202 updates connection destination information of the connection port p2 of the module M3 in the module connection relation table to “NC (Not Connected)”.

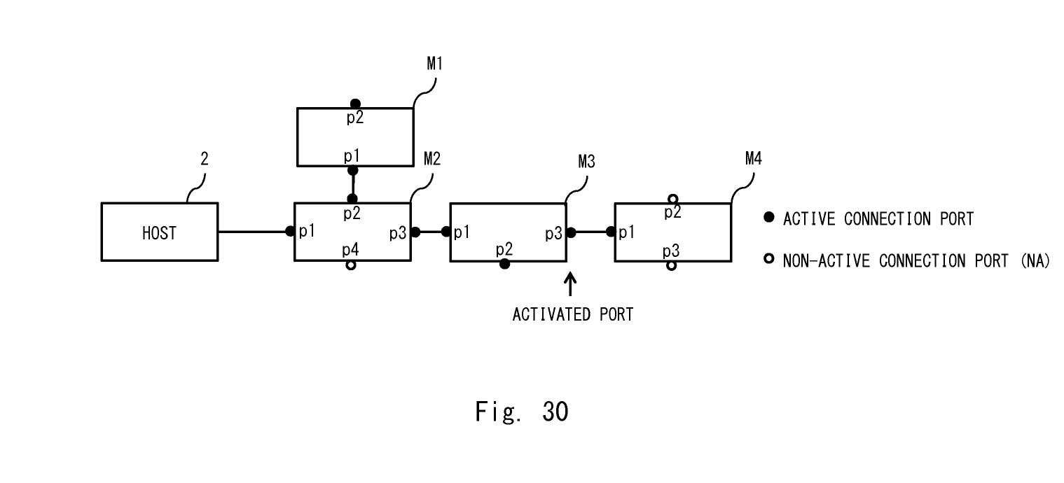

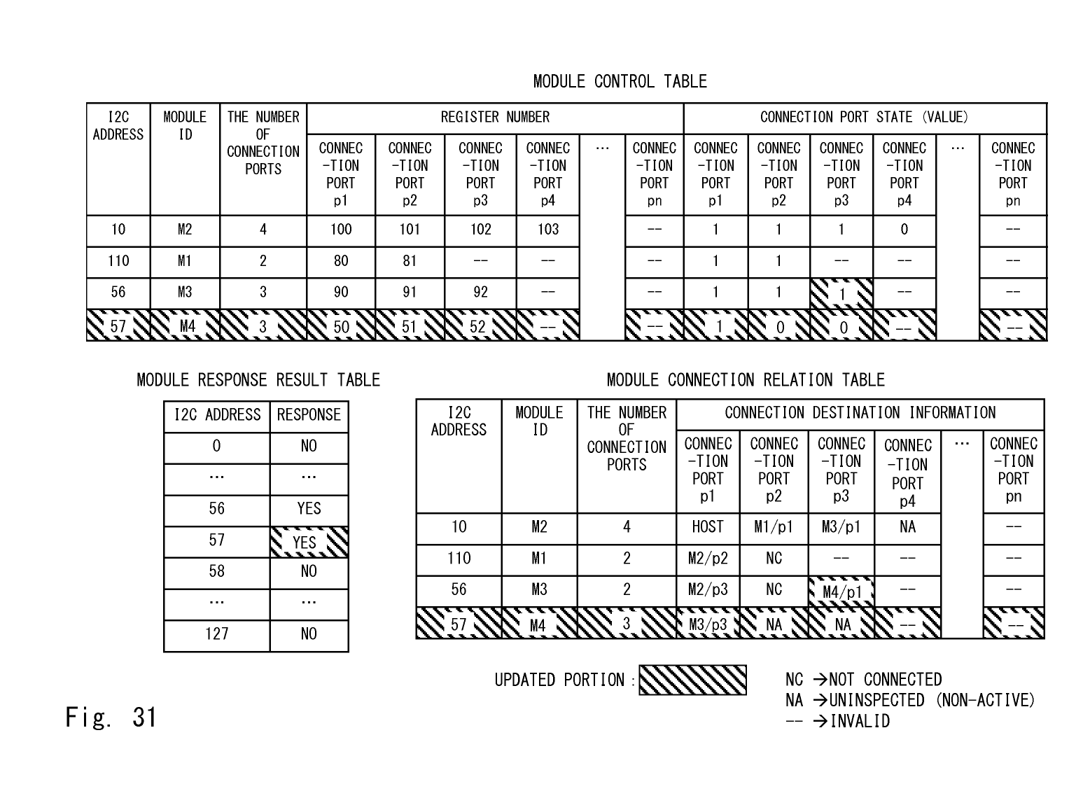

FIG. 30 illustrates a state where connection relation detection processing moves to next loop processing from the first state. The state illustrated in FIG. 30 is the second state. FIG. 31 is a view illustrating information stored in the connection detecting database 209 in the second state illustrated in FIG. 30.

In this state, the connection relation managing unit 202 makes a connection request for the connection port p3 of the module M3, and, as illustrated in FIG. 30, the connection port p1 at the host 2 side and the connection port p3 are newly connected in the module M3. In this case, a state of the connection port p3 of the module M3 in the module control table is updated to “1”. The connection port p3 of the module M3 is connected with the connection port p1 of the module M4. Hence, by acquiring the module ID list, the module ID “M4” of the module M4 is detected as a new module ID. Further, in this case, the module M4 has made a response to the ID return command for specifying an I2C address “57”.

In this case, as illustrated in FIG. 31, information in the connection detecting database 209 is updated. The connection relation managing unit 202 updates to “yes” whether or not there is a response to the I2C address “57” in the module response result table since there has been a new response to the ID return command for specifying the I2C address “57” from the module M4.

Further, the connection relation managing unit 202 adds an item of the module M4 of the new module ID “M4” to the module control table and the module connection relation table since the new module ID “4” has been returned since there is a response of the new module ID “M4”. In this case, as an I2C address and a module ID in the module control table and the module connection relation table, the I2C address “57” specified when a response is made from the module M4 and the module ID “M4” notified according to this notification are set.

The connection relation managing unit 202 sets to the number of connection ports in the module control table and the module connection relation table the number of connection ports “3” acquired by the connection port number acquiring unit 201 by using the new module ID “M4” as a key. The connection relation managing unit 202 sets to a register number (connection port address) of the connection port of the new module M4 connection port addresses “50” to “52” of module data acquired by the information inquiring means 26 by using the new module ID “M4” as a key.

The new module M4 is notified of the connection port p1 as the connection port p connected with the module M3 in the module M4 according to the ID return notification. Hence, the connection relation managing unit 202 sets “1” to the state of the connection port p1 of the module M4 in the module control table. The connection relation managing unit 202 sets “0” to the states of the connection ports p2 and p3 of the module M4 since the other connection ports p2 and p3 of the module M4 are not yet connected.

Further, the connection relation managing unit 202 sets the connection port p3 of the module M3 and the connection port p1 of the module M4 as mutual connection destinations in the module connection relation table. The connection relation managing unit 202 sets “NA (uninspected)” to connection destination information of the connection ports p2 to p4 of the module M4 since the other connection ports p2 to p4 of the module M4 are not yet connected.

As described above, in the first embodiment, the connection detecting function 10 of the host 2 issues a connection change command to the module M to connect to this module M and detects the module M newly recognized through the module M. Further, the virtual model generating function 11 of the host 2 generates a virtual model having a shape formed by a plurality of modules M based on a connection relation of a plurality of modules M detected by the connection detecting function 10.

Thus, it is possible to employ for a configuration of module M a simple configuration of changing connection states of the connection ports according to the connection change command from the host 2, and detect a connection relation of a plurality of modules M. Consequently, it is possible to suppress cost and power consumption.

Further, in the first embodiment, a communication path which connects the host 2 and each module M is constructed as a bus. In this case, there is a problem that it is difficult to specify the connection relation of the modules M. However, when a communication path is constructed as a bus, there is an advantage that it is possible to suppress the number of signals even if the number of connection ports is increased. By contrast with this, in the first embodiment, as described above, the simple configuration of changing connection states of the connection ports p can solve this problem and specify a connection relation of the modules M by way of communication through the bus. Consequently, it is possible to construct the communication path as a bus and suppress the number of signals.

Meanwhile, when a communication path which connects the host 2 and each module M is constructed by P2P (peer to peer) which is typically TCP/IP, it is easy to specify a connection relation of each module M. However, there is a problem that, when the number of connection ports increases, the number of signals increases. Further, in this case, it is also necessary to provide a power supply device to each module M. In the first embodiment, the communication path is constructed as a bus, and therefore such a problem does not occur.

### Second Embodiment

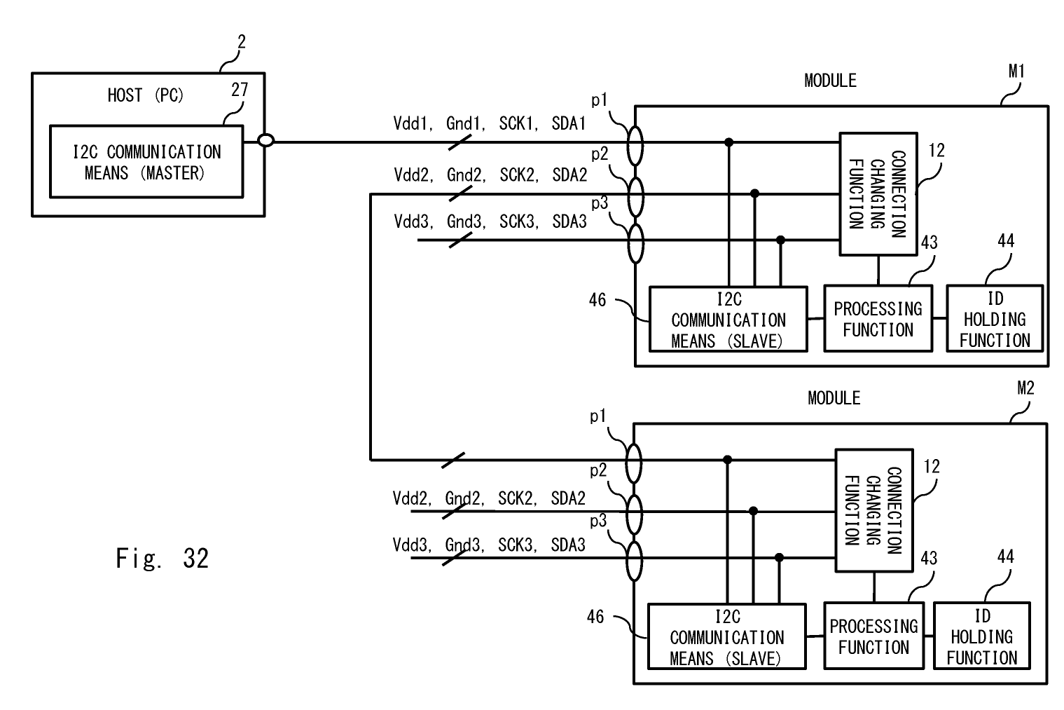

Next, the second embodiment will be described with reference to FIG. 32. The same contents as those in the first embodiment will not be described below, and contents different from those of the first embodiment will be described.

As illustrated in FIG. 32, in the second embodiment, a host 2 includes IC communication means 27 instead of communication control means 23 compared to the first embodiment. Further, in the second embodiment, a module M includes I2C communication means 46 instead of a communication function 42 compared to the first embodiment. That is, in the second embodiment, an example where I2C is adopted as communication standards for the host 2 and each module M will be described.

The I2C communication means 27 converts information outputted from module ID acquiring means 21 and command generating means 22 into a format (I2C frame) which complies with an I2C protocol, and transmits the information to each module M. Further, the I2C communication means 27 converts the information received from each module M into a format which can be processed in the host 2, and outputs the information to the module ID acquiring means 21 and the command generating means 22.

The I2C communication means 46 converts information outputted from a processing function 43 into a format (I2C frame) which complies with an I2C protocol, and transmits the information to each module M. Further, the I2C communication means 46 converts the information received from each module M into a format which can be processed in the host 2, and outputs the information to the processing function 43.

In this regard, in the second embodiment, the I2C communication means 27 of the host 2 includes a master function, and the I2C communication means 46 of each module M includes a slave function. The slave function can be mounted at low cost compared to the master function. That is, it is possible to reduce cost of each of a plurality of module M which need to be prepared. Consequently, it is possible to suppress cost of the virtual model generating system 1. As illustrated in, for example, FIGS. 16 and 18, the communication function 42 (I2C communication means 46) can be included in a microcomputer 4000, so that it is possible to suppress cost of the virtual model generating system 1.

### Third Embodiment

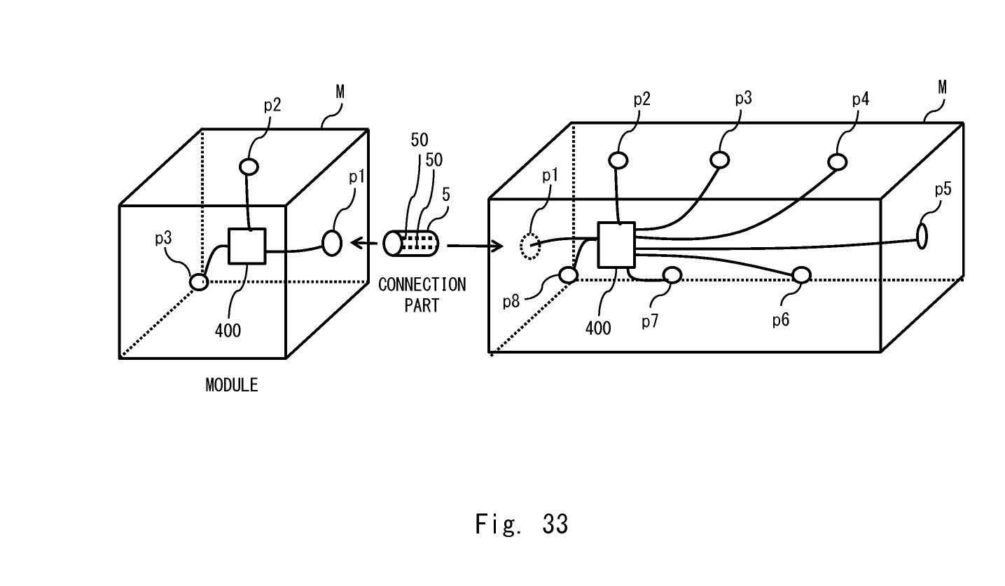

Next, the third embodiment will be described with reference to FIG. 33. The same contents as those of the first embodiment will not be described, and different contents from those of the first embodiment will be described.

FIG. 33 illustrates an example where each module M is a cube or a cuboid. In the third embodiment, as illustrated in FIG. 33, a connection port p of each module M is not directly connected, and is connected through a connection part 5. At least part of the connection part 5 is inserted in each module M. One end of the connection part 5 is connected to one module M, and the other end of the connection part 5 is connected to the other module M, so that the two modules Mare connected. The connection part 5 includes wirings 50 including signal lines S, power voltage lines Vdd and ground lines Gnd. The wirings 50 connect the signal lines S, the power voltage lines Vdd and the ground lines Gnd of the two modules M.

In an example in FIG. 2, mechanical and electrical connection is established between modules by using concave and convex shapes. However, in this case, only a convex module can be connected to a convex module, and therefore connection is limited. In the present embodiment, modules are connected by using concave type and convex type connectors, and, consequently, can be freely connected without being limited.

As described above, each module M may be mechanically and electrically connected through the connection part 5

### Fourth Embodiment

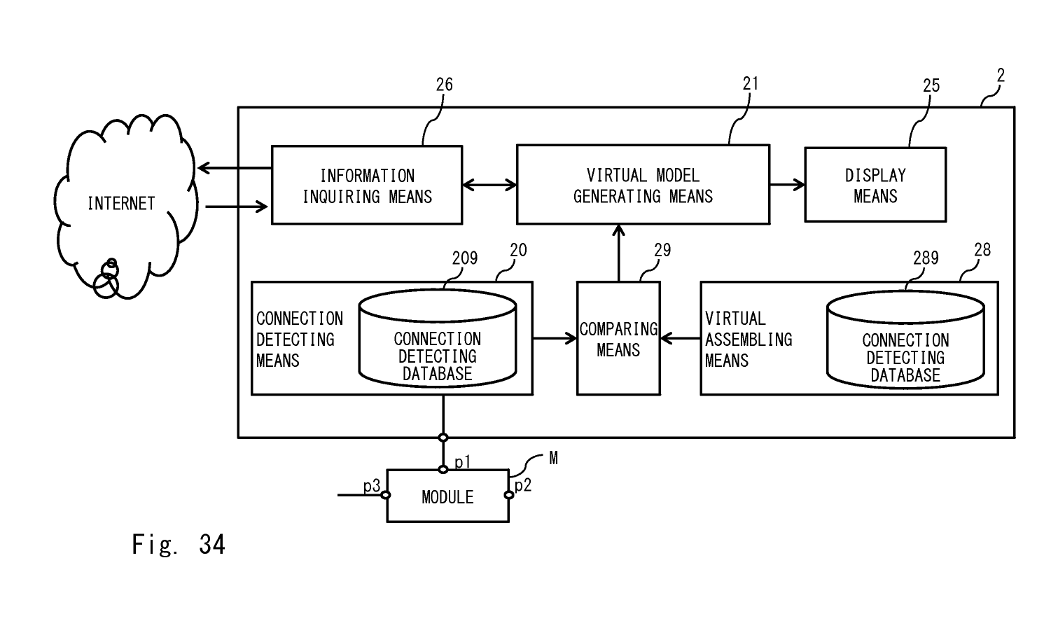

Next, the fourth embodiment will be described with reference to FIG. 34. The same contents as those in the first embodiment will not be described, and contents different from those of the first embodiment will be described.

As illustrated in FIG. 34, in the fourth embodiment, a host 2 includes virtual assembling means 28 and comparing means 29 compared to the first embodiment.

The virtual assembling means 28 generates a connection detecting database 289 as information indicating a connection relation of a plurality of modules M according to a user's input of the connection relation of a plurality of modules M through input means (not illustrated) of the host 2. The inputted connection relation of a plurality of modules M is a connection relation expected when a plurality of modules M are actually connected.

The connection detecting database 289 is information indicating a connection relation of a plurality of modules M. The connection detecting database 289 indicates a connection relation of a plurality of modules M in the same format as that of a connection detecting database 209.

The comparing means 29 compares the connection relation of a plurality of modules M indicated by the connection detecting database 209 and a connection relation of a plurality of modules M indicated by a connection detecting database 289. The comparing means 29 outputs comparison result information indicating a comparison result, to virtual model generating means 24.

The virtual model generating means 24 displays on display means 25 the comparison result indicating the comparing result information outputted from the comparing means 29. For example, the virtual model generating means 24 highlights a portion different from an expected connection relation in a virtual model displayed on the display means 25. When, for example, the module M different from the expected module M is connected, this module M may be highlighted. Further, when, for example, a connection port p is expected to be connected with another module M, if this connection port p is not connected with another module M, this connection port p may be highlighted. Furthermore, when, for example, the connection port p is expected not to be connected with another module M, if this connection port p is connected with another module M, this connection port p or this module M may be highlighted. For example, this connection port p or this module M may be highlighted by a color different from that of the normally connected connection port p and module M.

Consequently, it is possible to easily recognize a portion different from an expectation in a physical model formed by connecting a plurality of modules M by a user. Consequently, it is possible to prevent mistakes of parts and lack of parts in the physical model. Further, it is possible to minimize a reassembly and, consequently, it is possible to prevent connection portion of each module M from deteriorating.

### Fifth Embodiment

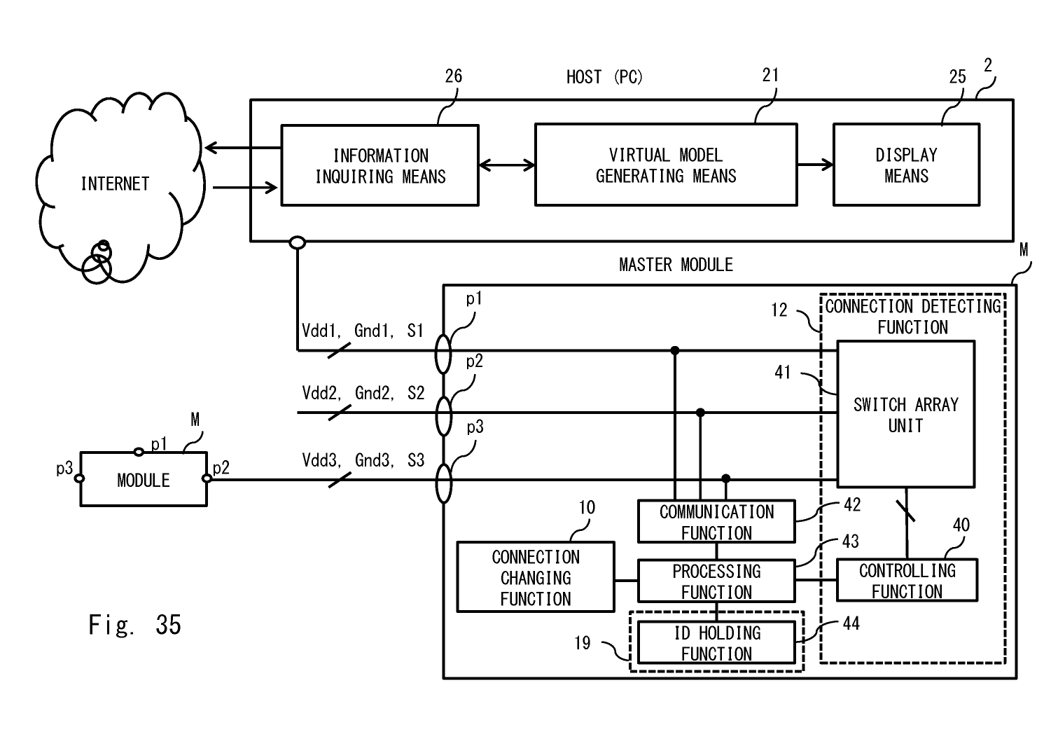

Next, the fifth embodiment will be described with reference to FIG. 35. The same contents as those in the first embodiment will not be described below, and contents different from those of the first embodiment will be described.

As illustrated in FIG. 35, in the fifth embodiment, a connection detecting function 10 includes a master module M instead of a host 2 compared to the first embodiment. The master module M is one of a plurality of modules M.

According to this, similar to the first embodiment, the connection detecting function 10 includes only one master module M, so that the other modules M can employ a simple configuration. Consequently, similar to the first embodiment, it is possible to suppress cost and power consumption of a virtual model generating system 1.

### Sixth Embodiment

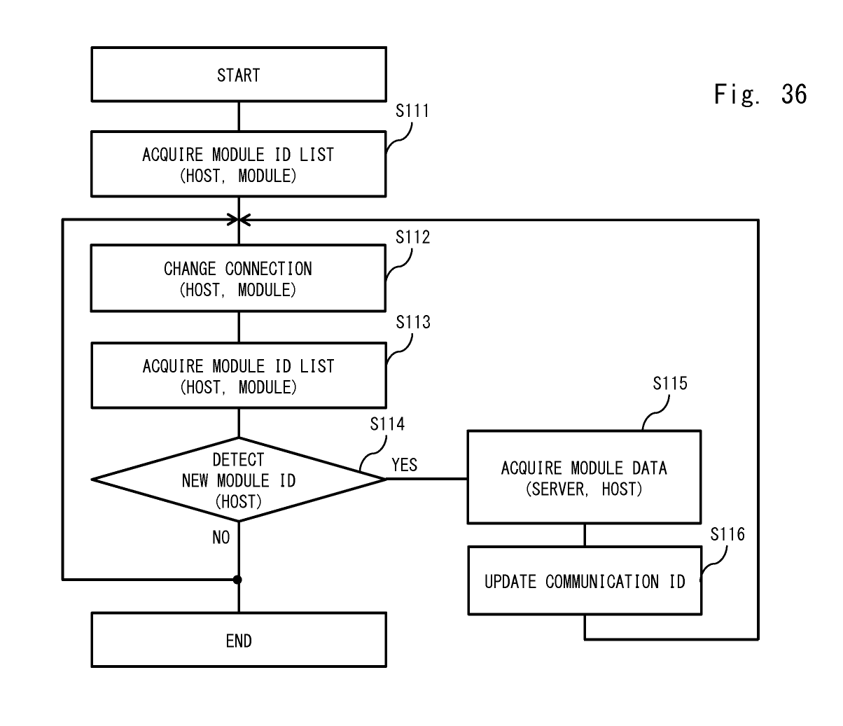

Next, the sixth embodiment will be described with reference to FIG. 36. The same contents as those in the first embodiment will not be described, and contents different from those of the first embodiment will be described.

In the sixth embodiment, a method of preventing collision of I2C addresses when I2C is adopted as communication standards for a host 2 and a module M will be described. When I2C is adopted for the communication standards for the host 2 and the module M, the number of I2C addresses is 128 (0 to 127), and therefore, when the number of modules M is great, I2C addresses overlap and communication cannot be normally performed.

Hence, in the sixth embodiment, when an I2C address of the new module M overlaps the I2C address of the module M which has already been recognized upon acquisition of a module ID list, module ID acquiring means 21 changes one of the I2C addresses of the modules M such that the I2C addresses do not overlap to enable normal communication (S116). For example, the module ID acquiring means 21 may change the I2C address of the module M to an I2C address which has not made a response to an ID return request. Further, this I2C address overlapping preventing method may use a general technique, and a function of an SM (System Management) bus may be used.

Furthermore, the module ID acquiring means 21 update the I2C address of the module M whose I2C address has been changed, too, to the changed I2C address in a module control table and a module connection relation table. Consequently, command generating means 22 can also communicate with the module M whose I2C address has been changed based on the module control table.

### Other Embodiment

Use of a bus configured by connecting a host 2 and a plurality of modules M in each of the above first to sixth embodiments is not limited only to detect a connection relation of a plurality of modules M. When, for example, a physical model formed by connecting a plurality of modules M is a gadget which operates, a bus which transmits a control signal for controlling each module M upon this operation may be appropriated.

For example, in the example illustrated in FIG. 5, a processing function 43 of a module M1 may include a function of controlling another module M, and the processing function 43 of the module M1 may transmit a control signal to another module M through the bus. For example, the processing function 43 of the module M1 may transmit a control signal for requesting switching of a gear, to a module M6 which functions as a gear box. In this case, after a connection relation of modules is acquired, all ports are switched to on for use.

Further, in this case, the module M1 is mounted as the master module M described with reference to FIG. 35. Further, a connection detecting function 10 of the module M1 may detect that part of the modules M have been detached. More specifically, the connection detecting function 10 acquires a module ID list on a regular basis. When detecting a module ID which exists in a previously acquired module ID yet does not exist in a module ID acquired this time, the connection detecting function 10 determines that the module M of this module ID has been detached. Further, the processing function 43 performs control to stop an operation of the gadget, for example, when the connection detecting function 10 detects that part of the modules M have been detached. Consequently, it is possible to prevent the gadget from losing control.

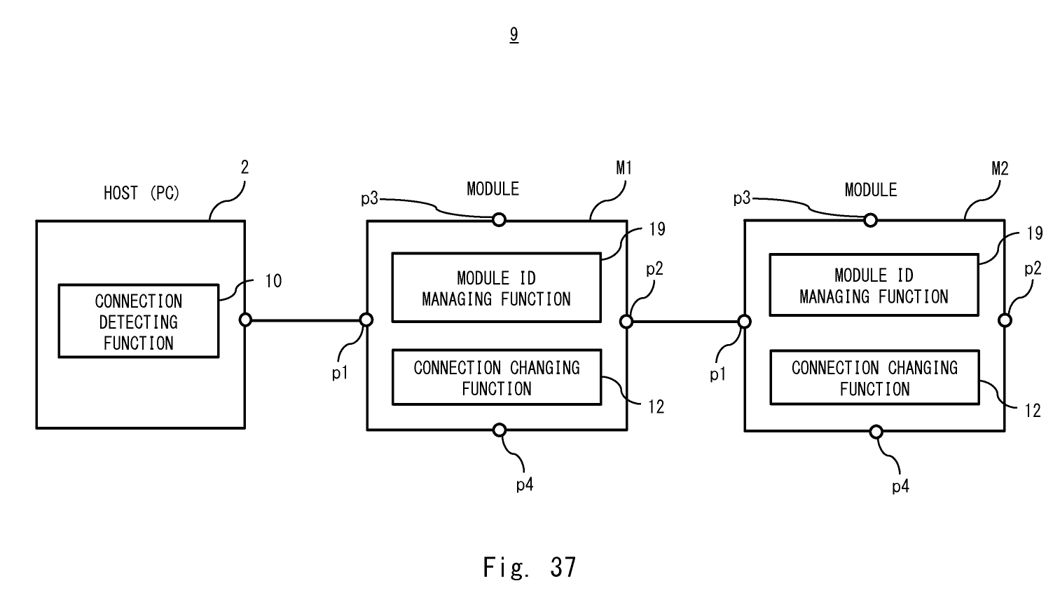

Further, as illustrated in FIG. 37, in a virtual model generating system 1, the host 2 may not include a virtual model generating function 11. That is, the host 2 may cause the connection detecting function 10 to only detect a connection relation of a plurality of modules M. In this case, the virtual model generating system 1 functions as a connection relation detecting system 9. Further, the connection relation of the modules M acquired in this way may be used not only for generation of the virtual model and comparison with a connection relation of the modules M inputted by a user, but also for various uses. Further, the connection detecting function 10 may display not only a virtual model but also a connection relation of the modules M on display means 25.

Further, a host program 299 and a server program 309 described above are stored in various types of non-transitory computer readable media, and can be supplied to computers (PCs and servers). The non-transitory computer readable media include various types of tangible storage media. The non-transitory computer readable media include, for example, magnetic recording media (e.g. flexible disks, magnetic tapes and hard disk drives), magnetooptical recording media (e.g. magnetooptical disks), CD-ROMs (Read Only Memory), CD-Rs, CD-R/Ws, and semiconductor memories (e.g. mask ROMs, PROMs (Programmable ROM), EPROMs (Erasable PROM), flash ROMs and RAMs (Random Access Memory)). Further, programs may be supplied to computers by using various types of transitory computer readable media. The transitory computer readable media include, for example, electric signals, optical signals and electromagnetic waves. The transitory computer readable media can supply programs to computers through wired channels such as wires and optical fibers and wireless channels.

The invention made by the inventors has been specifically described based on the embodiments above. However, the present invention is not limited to the above-described embodiments, and can be variously changed without departing from the spirit of the invention.

For example, by providing items of data 301 to 307 related to the module M, to the host 2 without providing the server 3 to the virtual model generating system 1, the host 2 may be allowed to acquire module data without making an inquiry to the server 3. However, preferably, the virtual model generating system 1 may include the server 3 as in each of the above-described embodiments 1 to 6. By so doing, when a change occurs in module data, it is possible to support the change by changing module data of the server 3.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

The first to sixth embodiments can be combined as desirable by one of ordinary skill in the art.

What is claimed is:

1. A connection relation detecting system comprising:
a plurality of modules which include a plurality of connection ports which can connect with another module; and
an information processing device which, when the plurality of modules are connected with each other, is connected to one of the plurality of modules through the connection ports, wherein
each of the plurality of modules includes a connection changing unit which connects the connection ports inside the module in response to a connection change request from the information processing device, and
the information processing device includes a connection detecting unit which, when the information processing device makes the connection change request to the module, detects a module newly recognized through the module as a module connected to the module to which the connection change request is made.

2. The connection relation detecting system according to claim 1, wherein
each of the modules further includes a processing unit which returns a module ID for uniquely specifying the module to the information processing device in response to an ID return request from the information processing device, and
the connection detecting unit makes ID return requests to the plurality of modules, and recognizes a module specified by a newly detected module ID in a list of module IDs returned in response to the ID return requests as a new module.

3. The connection relation detecting system according to claim 1, wherein the connection detecting unit detects a connection relation of the plurality of modules by repeatedly setting the newly recognized module as a module to which the connection change request is made next.

4. The connection relation detecting system according to claim 1, wherein the connection detecting unit repeats making the connection change request to modules to connect each of connection ports of the module other than connection ports at a side of the information processing device, with a connection port at a side of the information processing device in order.

5. The connection relation detecting system according to claim 4, further comprising an external information processing device which communicates with the information processing device, and
the external information processing device includes
a storage unit which stores in advance a plurality of pieces of connection port number information indicating a number of connection ports of the plurality of modules, and
a controlling unit which transmits connection port number information of a module for which an information transmission request has been made, to the information processing device in response to the information transmission request from the information processing device, and
the connection detecting unit makes an information transmission request for a number of connection ports of the newly recognized module, to the external information processing device, and recognizes the connection port number indicated by the connection port number information transmitted in response to the information transmission request as the number of connection ports of the newly recognized module.

6. The connection relation detecting system according to claim 5, wherein
the plurality of pieces of connection port number information indicate different numbers of connection ports,
in the storage unit, link information which links a module ID for uniquely specifying the module and connection port number information indicating a number of connection ports of the module specified based on the module ID is stored in advance,
the connection detecting unit specifies a module ID of the module newly recognized by the information transmission request, and
the control unit transmits the connection port number information linked to the module ID specified by the information transmission request, to the information processing device based on the link information stored in the storage unit.

7. The connection relation detecting system according to claim 5, wherein the information processing device further includes a virtual model generating unit which generates a virtual model of a shape formed by the plurality of modules based on a connection relation of the plurality of modules detected by the connection detecting unit.

8. The connection relation detecting system according to claim 7, wherein
in the storage unit, a plurality of pieces of shape/connection port information indicating shapes and connection port coordinates of the plurality of modules are further stored in advance,
the control unit transmits connection port number information of a module requested by the information transmission request and, in addition, shape/connection port information of the module requested by the information transmission request, to the information processing device, and
the virtual model generating unit generates the virtual model based on the connection relation of the plurality of modules and, in addition, shapes and the connection port coordinates of the plurality of modules transmitted from the external information processing device.

9. The connection relation detecting system according to claim 4, wherein
the connection changing unit includes switches each of which connects with the connection port at the side of the information processing device to meet each of connection ports other than the connection port at the side of the information processing device, and
the connection changing unit connects the connection port corresponding to the switch, and the connection port at the side of the information processing device by switching the switch to on.

10. The connection relation detecting system according to claim 9, wherein
the connection changing unit further includes a switch which connects the connection ports other than the connection port at the side of the information processing device to meet the connection port at the side of the information processing device, and
the connection changing unit connects the connection port other than the connection port at the side of the information processing device, and the connection port at the side of the information processing device by switching to on the switch corresponding to the connection port other than the connection port at the side of the information processing device and the switch corresponding to the connection port at the side of the information processing device.

11. The connection relation detecting system according to claim 10, wherein
the connection changing unit connects signal lines between the connection ports to connect the connection ports, and
each of the modules further includes a processing unit which detects a connection port whose information transmitted through the signal lines from the information processing device when a new module is recognized has been received, and switches to on a switch corresponding to the detected connection port as the switch corresponding to the connection port at the side of the information processing device.

12. The connection relation detecting system according to claim 11, wherein
each of the modules further includes a switching unit which connects one of the signal lines of the plurality of connection ports, and the processing unit in order, and
the processing unit controls the switching unit to maintain the connection between the signal line of the connection port whose information transmitted when the new module is recognized has been received, and the processing unit.

13. The connection relation detecting system according to claim 10, wherein
the connection changing unit connects power voltage lines between the connection ports as connection of the connection ports, and
each of the modules further includes
a voltage detecting unit which detects a connection port with which a voltage is supplied from the information processing device through the power voltage line, and
a processing unit which switches to on a switch corresponding to the connection port detected by the voltage detecting unit as a switch corresponding to the connection port at the side of the information processing device.

14. The connection relation detecting system according to claim 13, wherein each of the modules includes for each of the power voltage lines of the plurality of connection ports a plurality of diodes whose anodes are respectively connected with power voltage lines of the plurality of connection ports and whose cathodes are connected to a side of the module to which the voltage is supplied.

15. The connection relation detecting system according to claim 2, wherein
the information processing device communicates with each of the plurality of modules according to an I2C protocol,
one of I2C addresses is allocated to each of the plurality of modules, and
the connection detecting unit acquires a list of the module IDs by specifying all I2C addresses as transmission destinations of the ID return request in order, and repeatedly making the ID return request and acquiring module IDs returned in response to the ID return request.

16. The connection relation detecting system according to claim 15, wherein
the information processing device communicates with each of the plurality of modules as an I2C master, and
each of the plurality of modules communicates with the information processing device as an I2C slave.

17. The connection relation detecting system according to claim 1, wherein the information processing device further includes a comparing unit which compares a connection relation of the plurality of modules set in advance by a user and a connection relation of the plurality of modules detected by the connection detecting unit.

18. The connection relation detecting system according to claim 15, wherein, when an I2C address of the newly recognized module overlaps an I2C address of a module which has been already recognized, the connection detecting unit changes the I2C address of one of the newly recognized module and the module which has been already recognized, to an I2C address which does not overlap.

19. An information processing device comprising a connection detecting unit which, when a plurality of modules including a plurality of connection ports are connected with each other through the connection ports, connects the connection ports inside the module through one of the connection ports of the plurality of modules, and detects a module newly recognized through the module as a module connected to the module in which the connection ports are connected.

20. A connection relation method comprising, when a plurality of modules including a plurality of connection ports are connected with each other through the connection ports, connecting the connection ports inside the module through one of the connection ports of the plurality of modules, and detecting a module newly recognized through the module as a module connected to the module in which the connection ports are connected.
